(19) United States
(12) Patent Application Publication
(10) Pub. No.: US 2017/0053003 A1
(43) Pub. Date: Feb. 23, 2017

(54) SYSTEM, METHOD FOR PROCESSING INFORMATION, AND INFORMATION TERMINAL

(71) Applicant: Tsuyoshi ENDOH, Kanagawa (JP)

(72) Inventor: Tsuyoshi ENDOH, Kanagawa (JP)

(73) Assignee: Ricoh Company, Ltd., Tokyo (JP)

(21) Appl. No.: 15/220,720

(22) Filed: Jul. 27, 2016

(30) Foreign Application Priority Data
Aug. 18, 2015 (JP) 2015-161434

(51) Int. Cl. G06F 17/30; G06F 3/0484; G06F 3/0482

(52) U.S. Cl. CPC G06F 17/30554; G06F 17/3053; G06F 3/0482; G06F 3/0484

(57) ABSTRACT

An information terminal connected to an information processing apparatus and one or more devices that execute processing of data received from the information processing apparatus via a network, the terminal includes: a display controller that displays a screen in which one or more pieces of history information stored in a storage that stores therein history information associating a device that has executed the processing and the processed data with each other is displayed and that is used for performing designation of processing based on the history information selected from the one or more pieces of history information and designation of a device to be caused to execute the processing; and a generating unit that generates instruction information for instructing the device designated on the screen to execute the processing of data corresponding to the history information selected from the one or more pieces of history information on the screen.

### CROSS-REFERENCE TO RELATED APPLICATIONS

The present application claims priority under 35 U.S.C. §119 to Japanese Patent Application No. 2015-161434, filed Aug. 18, 2015. The contents of which are incorporated herein by reference in their entirety.

### BACKGROUND OF THE INVENTION

1. Field of the Invention

The present invention relates to a system, a method for processing information, and an information terminal.

2. Description of the Related Art

A device cooperation system is conventionally known that in a conference held using various devices connected via a network achieves cooperative processing that performs processing with the device cooperated.

Japanese Unexamined Patent Application Publication No. 2006-92339 discloses a technique that, for the purpose of enabling images and documents handled in a conference to be retrieved later in connection with the conference, associates images and documents handled in a workspace of a conference with a context (the conference), for example.

However, in a conference, requests to see data projected or displayed during the conference again are often made. The technique disclosed in Japanese Unexamined Patent Application Publication No. 2006-92339 requires finding previously handled data from a folder to check the previously handled data and hence has a problem in that operability when an instruction about to which device the previously handled data is output is performed is bad.

### SUMMARY OF THE INVENTION

According to exemplary embodiments of the present invention, there is provided a system that comprises an information terminal, an information processing apparatus, and one or more devices that execute processing of data received from the information processing apparatus, the system comprising: a storage unit configured to store therein history information associating a device that has executed the processing and the processed data with each other; a display controller configured to display, on the information terminal, a screen in which one or more pieces of history information are displayed and that is used for performing designation of processing based on the history information selected from the displayed one or more pieces of history information and designation of a device to be caused to execute the processing; a generating unit configured to generate instruction information for instructing the device designated on the screen to execute the processing of data corresponding to the history information selected from the one or more pieces of history information on the screen displayed by the display controller; and a processing executing unit configured to execute the processing of the data based on the instruction information generated by the generating unit.

Exemplary embodiments of the present invention also provide a method for processing information by a system that comprises an information terminal, an information processing apparatus, and one or more devices that execute processing of data received from the information processing apparatus, the method comprising: displaying, on the information terminal, a screen in which one or more pieces of history information stored in a storage unit that stores therein history information associating a device that has executed the processing and the processed data with each other is displayed and that is used for performing designation of processing based on the history information selected from the displayed one or more pieces of history information and designation of a device to be caused to execute the processing; generating instruction information for instructing the device designated on the screen to execute the processing of data corresponding to the history information selected from the one or more pieces of history information on the screen displayed at the displaying; and executing the processing of the data based on the instruction information generated at the generating.

Exemplary embodiments of the present invention also provide an information terminal connected to an information processing apparatus and one or more devices that execute processing of data received from the information processing apparatus via a network, the information terminal comprising: a display controller configured to display a screen in which one or more pieces of history information stored in a storage unit that stores therein history information associating a device that has executed the processing and the processed data with each other is displayed and that is used for performing designation of processing based on the history information selected from the displayed one or more pieces of history information and designation of a device to be caused to execute the processing; and a generating unit configured to generate instruction information for instructing the device designated on the screen to execute the processing of data corresponding to the history information selected from the one or more pieces of history information on the screen displayed by the display controller.

### BRIEF DESCRIPTION OF THE DRAWINGS

FIG. 1 is a diagram of an example of a configuration of a system of an embodiment of the present invention;

FIG. 2 is a diagram of an example of a hardware configuration of an information processing server included in the system;

FIG. 3 is a diagram of an example of functions that the information processing server has;

FIG. 4 is a diagram of an example of a hardware configuration of an information terminal included in the system;

FIG. 5 is a diagram of an example of functions that the information terminal has;

FIG. 6 is a diagram of an example of functions provided by a client application;

FIG. 7 is a diagram of an example of history information;

FIG. 8 is a diagram of an example of an initial operating screen;

FIG. 9 is a diagram of an example of an operating screen;

FIG. 10 is a flowchart of an operation example of the information terminal;

FIG. 11 is a diagram of an example of the operating screen;

FIG. 12 is a diagram of an example of an input/output selection screen;

FIG. 13 is a diagram of an example of the input/output selection screen;

FIG. 14 is a flowchart of an example of search processing;

FIG. 15 is a diagram of an example of a file selection screen;

FIG. 16 is a diagram of an example of an input device selection screen;

FIG. 17 is a diagram of an example of an output device selection screen;

FIGS. 18A and 18B are diagrams of examples of an instruction operating screen;

FIG. 19 is a diagram of an example of the operating screen;

FIG. 20 is a flowchart of an operation example of the information terminal;

FIG. 21 is a diagram of an example of the operating screen;

FIG. 22 is a diagram of an example of the instruction operating screen;

FIG. 23 is a diagram of an example of the operating screen;

FIG. 24 is a diagram of an example of the operating screen;

FIG. 25 is a sequence diagram of an example of a processing procedure of an inter-device cooperative operation;

FIG. 26 is a diagram of an example of pieces of history information arranged in date and time ascending order;

FIG. 27 is a flowchart of an operation example of the information terminal;

FIG. 28 is a diagram of an example of pieces of history information arranged in date and time descending order;

FIG. 29 is a flowchart of an operation example of the information terminal;

FIG. 30 is a diagram of an example of pieces of history information arranged in processing time descending order;

FIG. 31 is a flowchart of an operation example of the information terminal;

FIG. 32 is a diagram of an example of pieces of history information in which pieces of history information containing cooperative processing information indicating an object of cooperative processing are arranged with priority;

FIG. 33 is a flowchart of an operation example of the information terminal;

FIG. 34 is a diagram of displaying, for two or more pieces of history information matching in data handled in processing, only any one piece of history information;

FIG. 35 is a flowchart of an operation example of the information terminal;

FIG. 36 is a diagram of an example of a hardware configuration of a projector included in the system;

FIG. 37 is a diagram of an example of a hardware configuration of an electronic blackboard included in the system; and

FIG. 38 is a diagram of an example of a hardware configuration of an MFP included in the system.

The accompanying drawings are intended to depict exemplary embodiments of the present invention and should not be interpreted to limit the scope thereof. Identical or similar reference numerals designate identical or similar components throughout the various drawings.

### DETAILED DESCRIPTION OF THE PREFERRED EMBODIMENTS

The terminology used herein is for the purpose of describing particular embodiments only and is not intended to be limiting of the present invention.

As used herein, the singular forms “a”, “an” and “the” are intended to include the plural forms as well, unless the context clearly indicates otherwise.

In describing preferred embodiments illustrated in the drawings, specific terminology may be employed for the sake of clarity. However, the disclosure of this patent specification is not intended to be limited to the specific terminology so selected, and it is to be understood that each specific element includes all technical equivalents that have the same function, operate in a similar manner, and achieve a similar result.

The following describes embodiments of a system, a method for processing information, and an information terminal according to the present invention in detail with reference to the accompanying drawings.

### First Embodiment

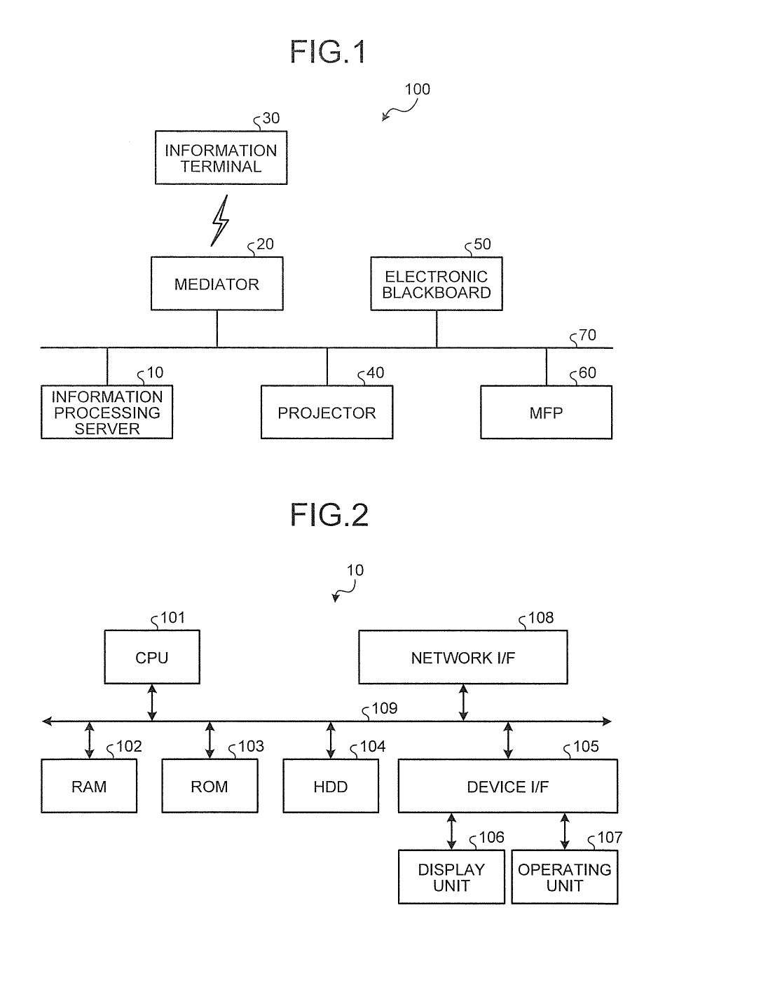

FIG. 1 is diagram of an example of a configuration of a system 100 of the present embodiment. The system 100 of the present embodiment is constructed as a network conference system with a logically closed environment. As illustrated in FIG. 1, the system 100 includes an information processing server 10, a mediator 20, an information terminal 30, a projector 40, an electronic blackboard 50, and an MFP 60. The information processing server 10, the mediator 20, the projector 40, the electronic blackboard 50, and the MFP 60 are connected via a network 70 for conference (hereinafter, simply referred to as a “network 70”). The mediator 20 is an access point, for example, and a range that radio waves emitted by the mediator 20 reach may be referred to as a “border.” The mediator 20 is a mediating unit for connecting the information terminal 30 (the information terminal 30 that a conference participant uses) present in the border to the network 70 using a wireless technique such as Bluetooth (registered trademark) and WiFi (registered trademark). Although FIG. 1 exemplifies one information terminal 30 for the convenience of description, this is not limiting, and any number of information terminals 30 are connected to the network 70 via the mediator 20. Although the projector 40, the electronic blackboard 50, and the MFP 60 are exemplified as the devices included in the system 100 in the example in FIG. 1, this is not limiting, and the type and the number of the devices included in the system 100 can freely be changed. To sum up, the system 100 is only required to be a form that includes one or more devices that execute processing of data received from the information processing server 10.

The information processing server 10 is an example of an information processing apparatus and performs management of the entire conference, management (storage, deletion, and the like) of data, output control to devices (the projector 40, the electronic blackboard 50, the MFP 60, and the like), and the like. FIG. 2 is a diagram of an example of a hardware configuration of the information processing server 10. As illustrated in FIG. 2, the information processing server 10 includes a central processing unit (CPU) 101, a random access memory (RAM) 102, a read only memory (ROM) 103, a hard disk drive (HDD) 104, a device I/F 105, and a network I/F 108, which are connected with each other via a bus 109. To the device I/F 105, a display unit 106 and an operating unit 107 are connected.

The CPU 101 is an arithmetic unit and comprehensively controls the operation of the entire information processing server 10. The RAM 102 is a volatile storage medium that enables high-speed reading and writing of information and is used as a work area when the CPU 101 processes information. The ROM 103 is a read-only non-volatile storage medium and stores therein computer programs such as firmware. The HDD 104 is a non-volatile storage medium that enables reading and writing of information and stores therein an operating system (OS), various kinds of control programs, application programs, and the like.

The device I/F 105 is an interface for connecting the display unit 106 and the operating unit 107 to the bus 109. The display unit 106 is a visual user interface for displaying various kinds of information and includes a liquid crystal display (LCD), for example. The operating unit 107 is a user interface, such as a keyboard and a mouse, for causing a user to input various kinds of information to the information processing server 10. The network I/F 108 is an interface for connecting the information processing server 10 to the network 70.

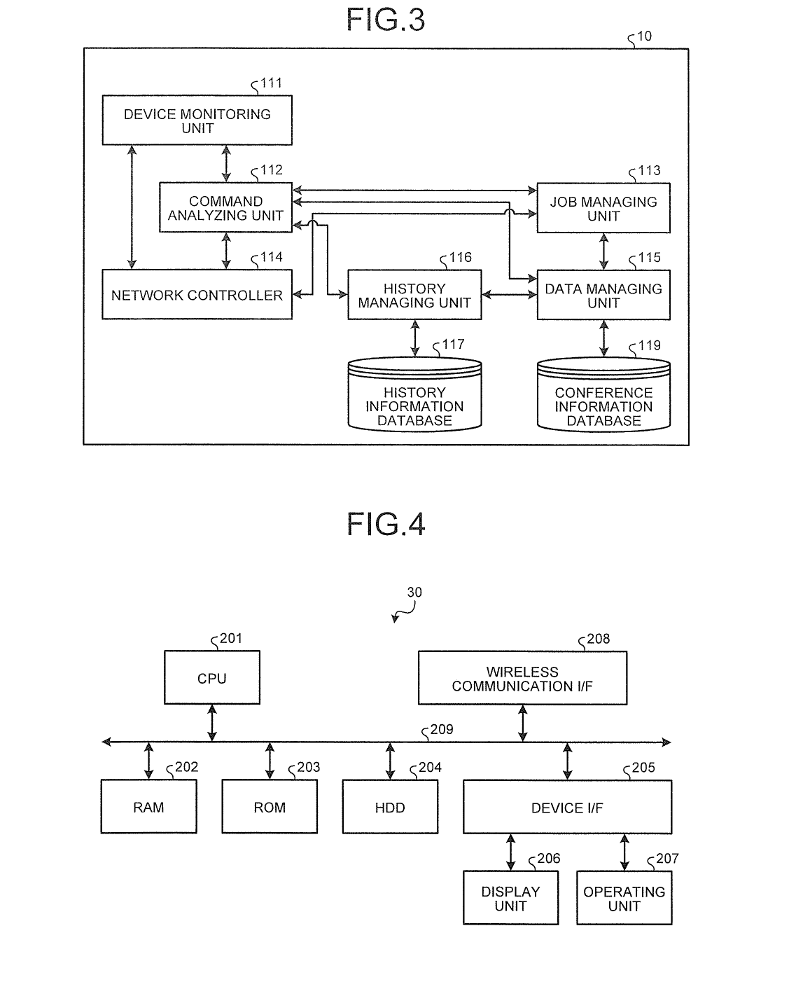

FIG. 3 is a diagram of an example of functions that the information processing server 10 has (functions executed by the CPU 101 of the information processing server 10). Although FIG. 3 mainly exemplifies the functions concerning the present embodiment for the convenience of description, the functions that the information processing server 10 has are not limited thereto. As illustrated in FIG. 3, the information processing server 10 includes a device monitoring unit 111, a command analyzing unit 112, a job managing unit 113, a network controller 114, a data managing unit 115, a history managing unit 116, a history information database 117, and a conference information database 119.

The device monitoring unit 111 monitors the other devices connected to the network 70 and the state thereof and manages available functions. The command analyzing unit 112 analyzes a command instruction (described below) received from the information terminal 30, compares the command instruction with the functions managed by the device monitoring unit 111 (the available functions), and notifies the job managing unit 113 of processing contents by the other devices. The command analyzing unit 112 receives information on conferences such as preparation and editing of a starting time, an ending time, and the like of conferences and participation and leaving in and from conferences (conference information) and requests the data managing unit 115 to update the conference information. Furthermore, the command analyzing unit 112 can also request the history managing unit 116 to acquire history information.

The job managing unit 113 generates (constructs) a job for any of the other devices from the contents notified of from the command analyzing unit 112, transmits the generated job, and receives a job response via the network controller 114. Image data acquired by the job response is delivered to the data managing unit 115. The network controller 114 controls information exchange with the outside via the network I/F 108 illustrated in FIG. 2.

The data managing unit 115 stores the conference information received from the command analyzing unit 112 and the image data received from the job managing unit 113 in the conference information database 119. In this example, the conference information database 119 integrally manages data (image data or the like) of materials used in conferences and can include the HDD 104, for example. The data managing unit 115 acquires the conference information and the image data from the conference information database 119 in response to a request from the command analyzing unit 112 or the job managing unit 113 and provides the conference information and the image data. The data managing unit 115 generates the history information and delivers the history information to the history managing unit 116. The data managing unit 115 generates the history information and delivers the history information to the history managing unit 116 every time the conference information or the image data acquired by the job response is stored, for example. Specific contents of the history information will be described below.

The history managing unit 116 stores (records) the history information that the data managing unit 115 has generated in the history information database 117. The history information database 117 can include the HDD 104, for example. The history managing unit 116 acquires the history information from the history information database 117 in response to a request from the command analyzing unit 112 and provides the history information.

Although the above-described functions that the information processing server 10 has (the device monitoring unit 111, the command analyzing unit 112, the job managing unit 113, the network controller 114, the data managing unit 115, and the history managing unit 116,) are implemented by causing the CPU 101 to execute the computer programs stored in the ROM 103 or the like, this is not limiting, and at least part of the functions that the information processing server 10 has may be configured by an exclusive hardware circuit, for example.

FIG. 4 is a diagram of an example of a hardware configuration of the information terminal 30. The information terminal 30 includes a mobile multifunction device (a smart device) such as a smartphone and a tablet. As illustrated in FIG. 4, the information terminal 30 includes a central processing unit (CPU) 201, a random access memory (RAM) 202, a read only memory (ROM) 203, a hard disk drive (HDD) 204, a device I/F 205, and a wireless communication I/F 208, which are connected with each other via a bus 209. To the device I/F 205, a display unit 206 and an operating unit 207 are connected.

The CPU 201 is an arithmetic unit and comprehensively controls the operation of the entire information terminal 30. The RAM 202 is a volatile storage medium that enables high-speed reading and writing of information and is used as a work area when the CPU 201 processes information. The ROM 203 is a read-only non-volatile storage medium and stores therein computer programs such as firmware. The HDD 204 is a non-volatile storage medium that enables reading and writing of information and stores therein an operating system (OS), various kinds of control programs, application programs, and the like.

The device I/F 205 is an interface for connecting the display unit 206 and the operating unit 207 to the bus 209. The display unit 206 is a visual user interface for displaying various kinds of information and includes a liquid crystal display (LCD), for example. The operating unit 207 is a user interface for causing a user to input various kinds of information to the information terminal 30 such as a keyboard and a mouse. The wireless communication I/F 208 is an interface for causing the information terminal 30 to perform wireless communication with the mediator 20.

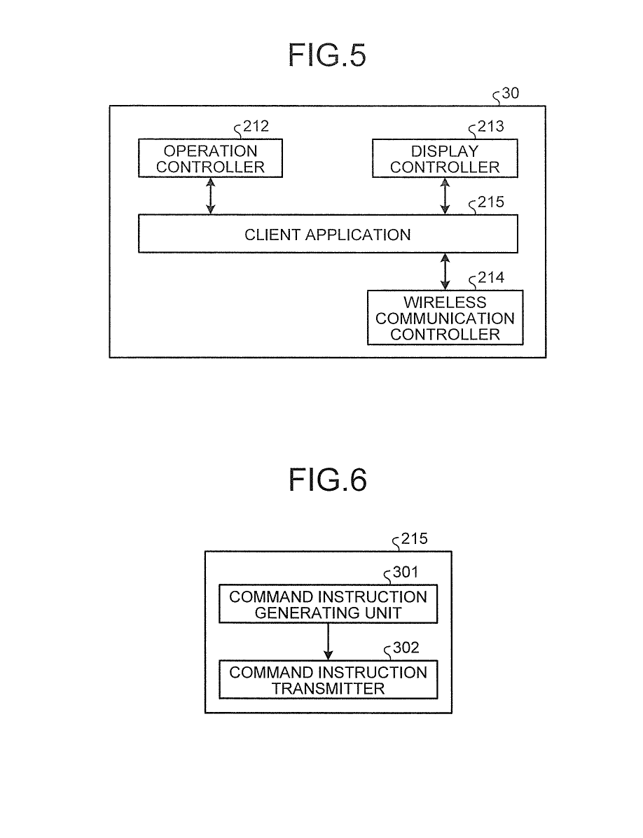

FIG. 5 is a diagram of an example of functions that the information terminal 30 has (functions executed by the CPU 201 of the information terminal 30). Although FIG. 5 mainly exemplifies the functions concerning the present embodiment for the convenience of description, the functions that the information terminal 30 has are not limited thereto. As illustrated in FIG. 5, the information terminal 30 includes an operation controller 212, a display controller 213, a wireless communication controller 214, and a client application 215. The operation controller 212 acquires an operation signal input via the operating unit 207 and inputs the operation signal to a module operating in the information terminal 30 such as the client application 215. It can also be considered that the operation controller 212 has the function of receiving operations by the user. The display controller 213 is an example of a “display controller” and performs control to display various kinds of information on the information terminal 30 such as a graphical user interface (GUI) of the client application 215 on the display unit 206. The wireless communication controller 214 controls communication with another device via the wireless communication I/F 208. The wireless communication controller 214 acquires information input via the wireless communication I/F 208 and transmits information to be transmitted to the other device via the wireless communication I/F 208, for example.

The client application 215 is a software module that provides various kinds of functions in the information terminal 30 and includes software programs corresponding to the respective functions. An exclusive application for utilizing the conference system according to the present embodiment is also contained in the client application 215.

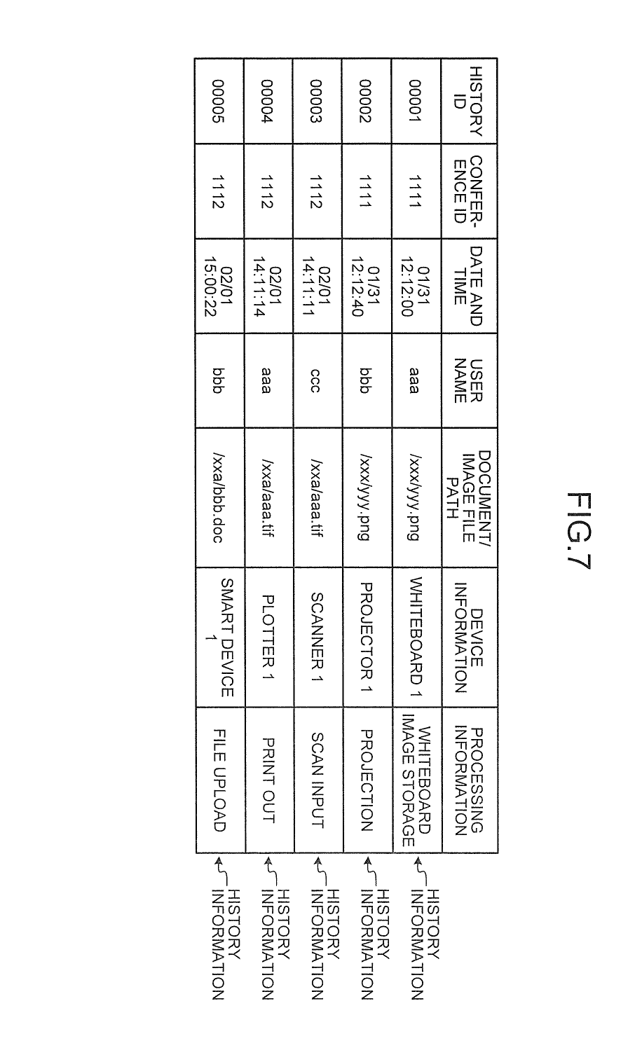

FIG. 6 is a diagram of an example of the functions provided by the client application 215. Although FIG. 6 exemplifies only the function according to the present embodiment for the convenience of description, the functions provided by the client application 215 are not limited thereto. As illustrated in FIG. 6, the client application 215 includes a command instruction generating unit 301 and a command instruction transmitter 302.

The command instruction generating unit 301 generates the command instruction in response to a user's operation received on an operating screen described below. Specific contents of the command instruction will be described below. The command instruction transmitter 302 transmits the command instruction generated by the command instruction generating unit 301 to the information processing server 10 via the mediator 20. The information processing server 10 that has received the command instruction generates a job based on the received command instruction. The information processing server 10 transmits the generated job to a target device and records the history information based on a job response received from the device. Specific contents of the history information will be described.

The history information is information that associates a device that has executed processing and the processed data with each other. In this example, the history information is information that associates a processing, a device that has executed the processing, and the processed data with each other. It can also be considered that the history information is information that associates at least a processing, data (image data, for example) handled in the processing, and a device (any device included in the system 100) that has executed the processing with each other. The data handled in the processing is data used in the processing or data obtained as a result of the processing. FIG. 7 is an example of the history information. The example in FIG. 7 exemplifies five pieces of history information. In this example, each of the respective pieces of history information is information that associates a history ID identifying the history information, a conference ID identifying a conference, a date and time when the processing was executed, a user name identifying a user (an operator) of the information terminal 30 that issued the command instruction, a document/image file path (a position at which the data is stored in the conference information database 119 in this example) identifying data handled in the processing, device information indicating a device that has executed the processing, and processing information indicating the contents of the processing with each other.

Although the above-described functions that the information terminal 30 has are implemented by causing the CPU 201 to execute the computer programs stored in the ROM 203 or the like, this is not limiting, and at least part of the functions that the information terminal 30 has may be configured by an exclusive hardware circuit, for example.

For the purpose of improving operability when an instruction about to which device previously handled data is output is performed, the system 100 of the present embodiment displays a screen (an operating screen of the information terminal 30) in which one or more pieces of history information are displayed and that is used for performing designation of processing based on history information selected from the displayed one or more pieces of history information and designation of a device to be caused to execute the processing and generates instruction information for instructing the device designated on the screen to execute the processing of data corresponding to the history information selected from the one or more pieces of history information on the displayed screen. More specifically, the screen receives selection of any of one or more pieces of history information and receives designation of the processing using data contained in the selected history information and designation of a device to execute the designated processing. The system 100 of the present embodiment has the function of generating the instruction information (the command instruction or the job described below) that instructs the designated device to execute the designated processing using the data contained in the selected history information based on a user's operation received on the screen.

In the present embodiment, the information terminal 30 generates the command instruction that designates processing to be executed and a device that executes the processing in response to a user's operation received on the screen containing one or more pieces of history information and designates data contained in the history information selected from the one or more pieces of history information as data to be handled in the processing and transmits the generated command instruction to the information processing server 10. The information processing server 10 that has received the command instruction generates a job to instruct (order) the device designated by the command instruction to execute the processing designated by the command instruction using the data designated by the command instruction. In this example, it can also be considered that a combination of the command analyzing unit 112 and the job managing unit 113 or at least either the command analyzing unit 112 or the job managing unit 113 corresponds to a “generating unit.” The information processing server 10 transmits the generated job to the target device (in other words, the information processing server 10 instructs the execution of the generated job). The device executes the processing corresponding to the job received from the information processing server 10 and then transmits a job response to the information processing server 10. In this example, the respective devices (the projector 40, the electronic blackboard 50, and the MFP 60 in this example) included in the system 100 have at least the function of executing the processing of data based on the job received from the information processing server 10 (a processing executing unit) and the function of executing the processing of the data based on the job and then transmitting the job response indicating that the processing of the data based on the job has been executed to the information processing server 10 (a response transmitter). The information processing server 10 has the function of recording the device that has executed the processing and the processed data as the history information based on the instruction information for instructing the processing of the data executed by the processing executing unit (a recording unit). More specifically, when receiving the job response from the device that has executed the processing based on the job generated by the information processing server 10 (the generating unit), the information processing server 10 records the history information that associates at least the processing corresponding to the job, the data handled in the processing corresponding to the job, and the device that has executed the processing corresponding to the job with each other.

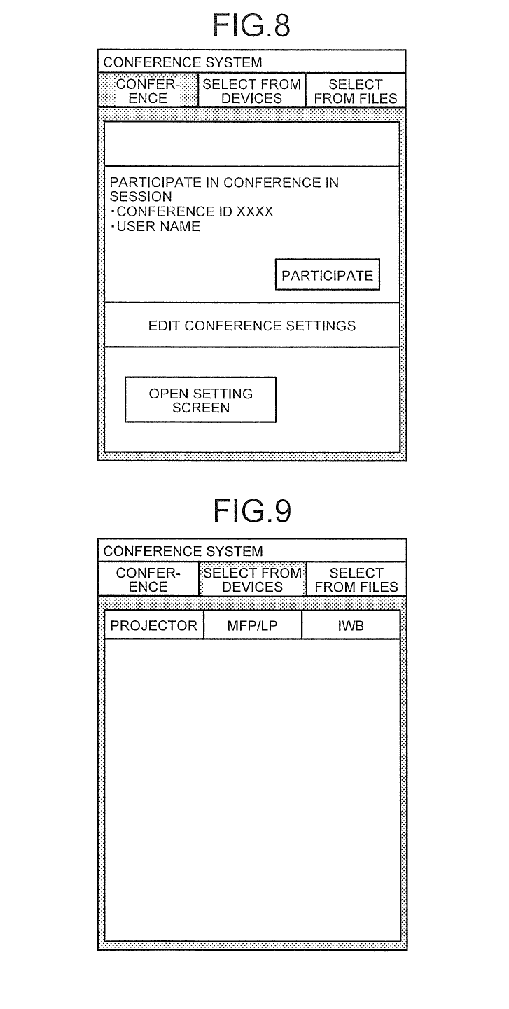

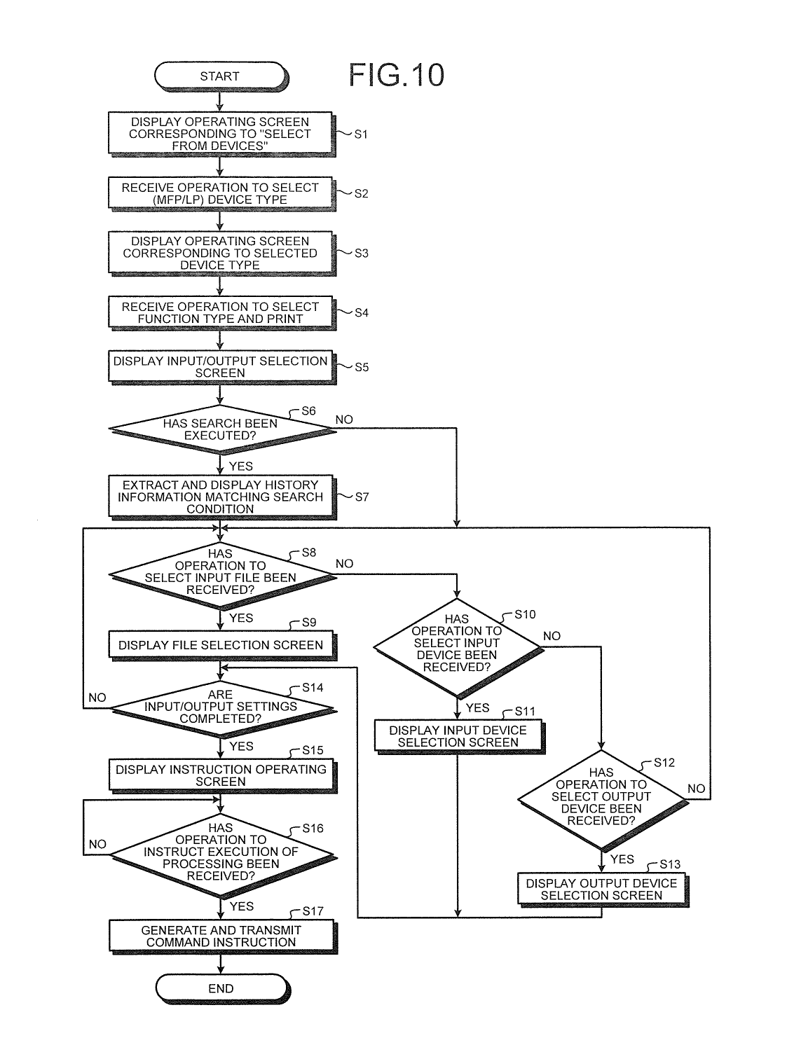

The following describes a method by which the information terminal 30 generates the command instruction. First, with an initial operating screen as illustrated in FIG. 8 displayed on the display unit 206, upon reception of an operation to select an item of “select from devices” (an operation to press an icon of “select from devices”), the display controller 213 displays the operating screen corresponding to “select from devices” as illustrated in FIG. 9 on the display unit 206. The following describes an example of screen transition from the operating screen corresponding to “select from devices” with reference to FIG. 10.

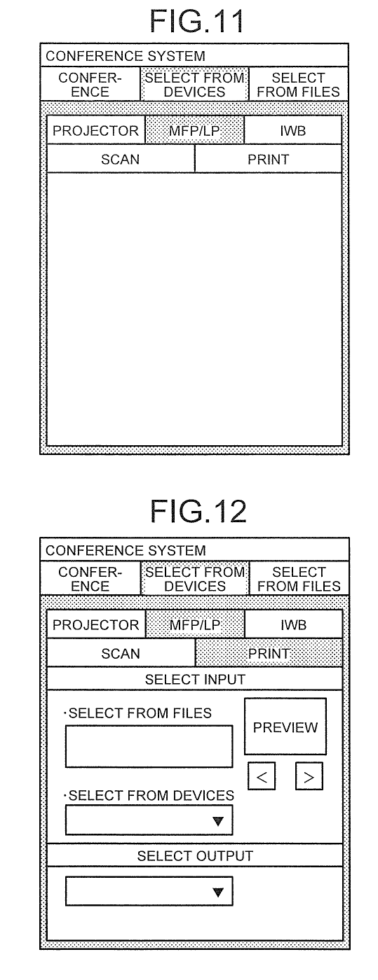

First, as illustrated in FIG. 10, the display controller 213 displays the operating screen corresponding to “select from devices” on the display unit 206 (Step S1). Next, an operation to select a device type is received (Step S2). This example will be described based on the premise that an operation to select “MFP/LP” as the device type (an operation to press an icon of “MFP/LP” illustrated in FIG. 9) has been received. Next, the display controller 213 displays the operating screen corresponding to the device type selected at Step S2 on the display unit 206 (Step S3). In this example, the operating screen corresponding to “MFP/LP” is as illustrated in FIG. 11.

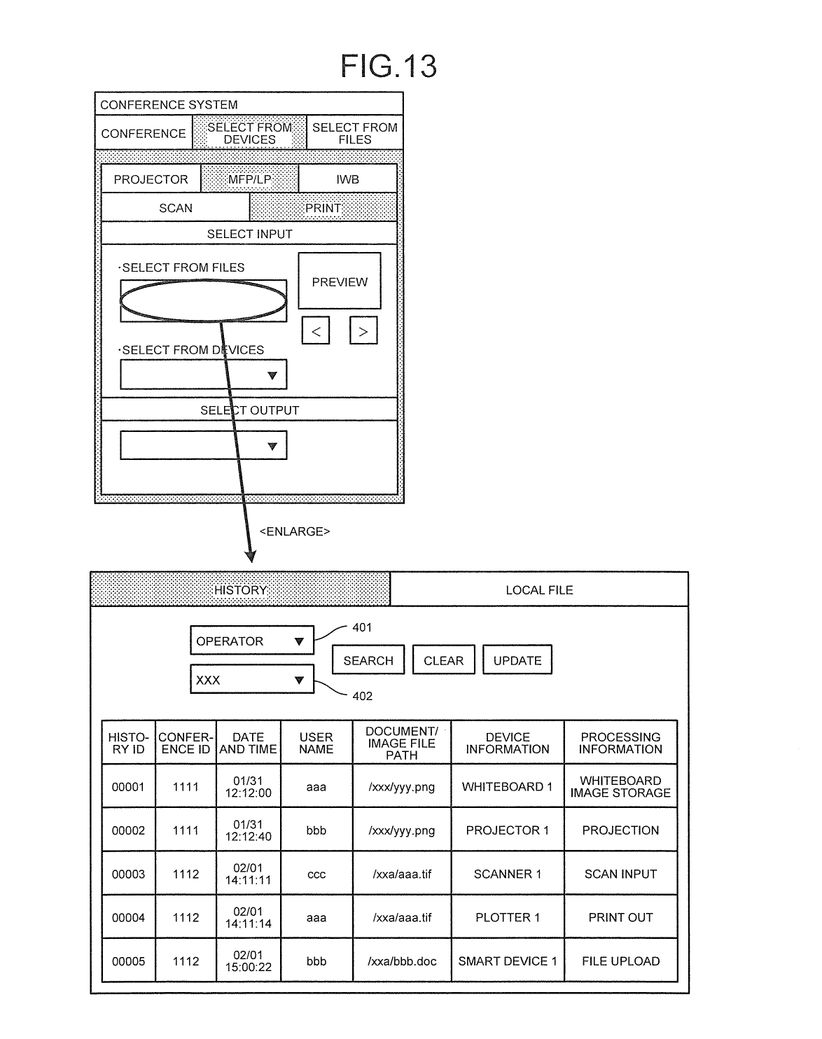

Next, an operation to select a function type is received (Step S4). This example will be described based on the premise that an operation to select “print” as the function type (an operation to press an icon of “print” illustrated in FIG. 11) has been received. Next, the display controller 213 displays an input/output selection screen as illustrated in FIG. 12 on the display unit 206 (Step S5). In this situation, the information terminal 30 (the display controller 213, for example) acquires the history information (the history information with an amount that can be displayed by the information terminal 30) held in the history information database 117 from the information processing server 10 and displays the pieces of history information on the input/output selection screen as illustrated in FIG. 13.

Only partial items among the items contained in the history information may be displayed, for example. For the convenience of description, the following may describe the history information contained in the screen (the input/output selection screen, for example) of the information terminal 30 as information that associates the processing information indicating processing, the date and time when the processing was executed, a file name (that can be identified by the document/image file path) indicating data handled in the processing, the device information indicating the device that has executed the processing, and the user name indicating the operator with each other. To sum up, the information terminal 30 is only required to display the history information that associates at least the processing, the date and time when the processing was executed, the data handled in the processing, and the device that has executed the processing with each other.

The following continuously describes FIG. 10. If search processing is executed (Yes at Step S6), the display controller 213 performs control to display the history information matching a search condition among the pieces of history information displayed on the input/output selection screen by default (the history information acquired from the information processing server 10) on the input/output selection screen (Step S7), and the process advances to Step S8. In other words, the display controller 213 performs the search processing to search for the history information matching the search condition among the pieces of history information displayed on the input/output selection screen by default and performs control to display the history information obtained as a result of the search processing on the screen. If the search processing is not executed (No at Step S6), the process advances to Step S8 without being processed.

The following describes the search processing. In this example, the user can select any one search item by a pull-down menu (a pull-down menu for selecting a search item) 401 illustrated in FIG. 13. Next, the user can select any one candidate by a pull-down menu 402 for selecting a candidate corresponding to the selected search item. With this operation, the history information containing the candidate of the selected search item among the pieces of history information on the input/output selection screen is an object to be searched for. In other words, the search condition indicating that the history information containing the candidate of the selected search item is searched for is set from among the pieces of default history information (the history information acquired from the information processing server 10). When an operation to instruct the execution of the search processing (an operation to press an icon of “search” in this example) has been received, the search processing is executed. When an operation to instruct to restore the default state (an operation to press an icon of “clear”) has been received, the selected search item and candidate are cleared (in other words, the set search condition is cleared), and the pieces of default history information are displayed again. With this operation, the user can perform the search processing again with the search condition changed. A plurality of icons (pull-down menus, for example) for selecting the search item may be provided, and an icon for selecting the corresponding candidate may be provided for each of the icons.

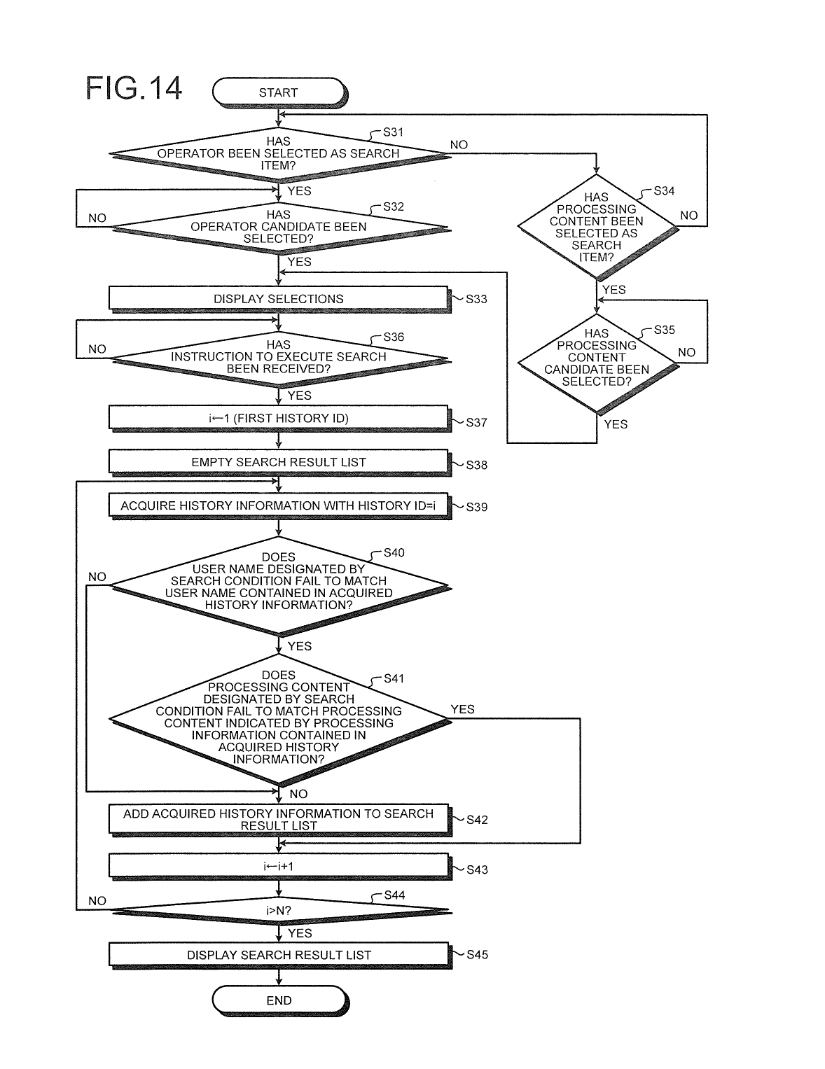

FIG. 14 is a flowchart of an example of the search processing. This example describes a case that the search condition can be set for searching for the history information containing the designated processing or searching for the history information containing a designated user name (operator). As illustrated in FIG. 14, it is checked whether “operator” has been selected as the search item (Step S31). If the result at Step S31 is affirmative (Yes at Step S31), it is checked whether any of the operator candidates has been selected (Step S32). If the result at Step S32 is affirmative (Yes at Step S32), the selections at Step S31 and Step S32 are displayed (Step S33).

In contrast, if the result at Step S31 is negative (No at Step S31), it is checked whether processing content has been selected as the search item (Step S34). If the result at Step S34 is affirmative (Yes at Step S34), it is checked whether any of the processing content candidates has been selected (Step S35). If the result at Step S35 is affirmative (Yes at Step S35), the selections at Step S34 and Step S35 are displayed (Step S33).

Following Step S33, it is checked whether the operation to instruct the execution of the search processing (the operation to press the icon of “search” illustrated in FIG. 13 in this example) has been received (Step S36). If the result at Step S36 is affirmative (Yes at Step S36), a number i of a target history ID is set to “1” (Step S37), and a search result list is emptied (Step S38). From the history ID with a number indicating “i” in order, the following processing is executed.

The display controller 213 acquires the history information corresponding to the history ID with the number indicating “i” from among the pieces of history information acquired from the information processing server 10 (the pieces of history information displayed on the input/output selection screen by default) (Step S39). Next, the display controller 213 checks whether the user name designated by the search condition fails to match the user name contained in the history information acquired at Step S39 (Step S40). If the result at Step S40 is affirmative (Yes at Step S40), the process advances to Step S41. If the result at Step S40 is negative (No at Step S40), the process advances to Step S42.

At Step S41, the display controller 213 checks whether the processing content designated by the search condition fails to match the processing content contained in the history information acquired at Step S39 (Step S41). If the result at Step S41 is affirmative (Yes at Step S41), the process advances to Step S43. If the result at Step S41 is negative (No at Step S41), the process advances to Step S42.

At Step S42, the display controller 213 adds the history information acquired at Step S39 to the search result list (Step S42) and increments the number i of the target history ID by “1” (Step S43). Next, it is checked whether the number i exceeds a last number N of the history ID (Step S44). If the result at Step S44 is affirmative (Yes at Step S44), the search result list is displayed (Step S45). If the result at Step S44 is negative (No at Step S44), the pieces of processing at Step S39 and the subsequent steps are repeated.

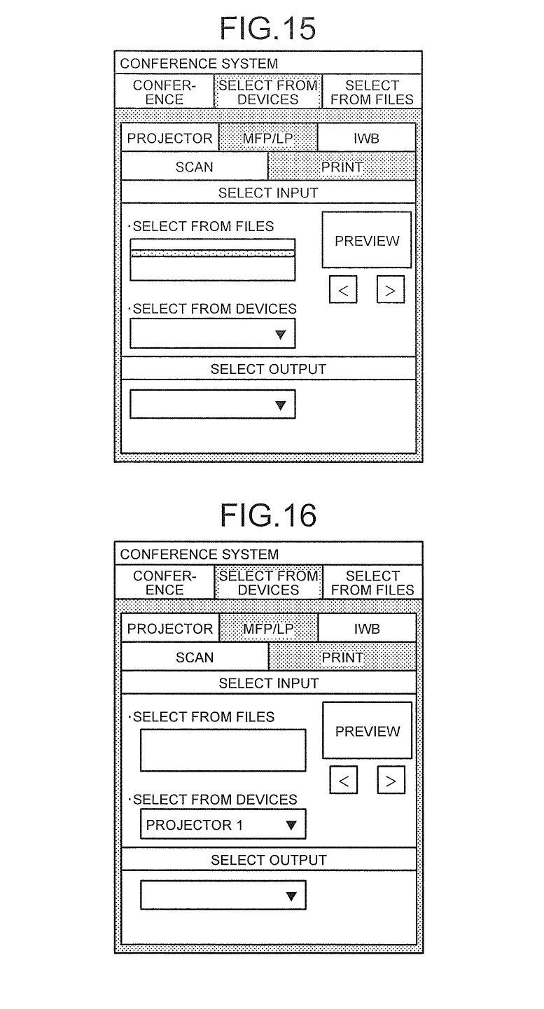

Referring back to FIG. 10, the description continues. If an operation to select an input file has been received at Step S8 (Yes at Step S8), the display controller 213 displays a file selection screen as illustrated in FIG. 15 on the display unit 206 (Step S9). The user can select any of the pieces of history information displayed on the input/output selection screen (the pieces of default history information or the search result list) as the input file and can also select the input file from data that the information processing server 10 holds as conference materials, for example. In this example, when an operation to press an icon of “local file” on the input/output selection screen illustrated in FIG. 13 has been received, the display controller 213 displays a list of the data that the information processing server 10 holds on the input/output selection screen, whereby the user can perform an operation to select any of the displayed data as the input file.

If the operation to select the input file has not been received (No at Step S8), and if an operation to select an input device has been received (Yes at Step S10), in other words, if an operation to select any device from a pull-down menu of “select from devices” of the input/output selection screen illustrated in FIG. 13 as the input device has been received in this example, an input device selection screen as illustrated in FIG. 16 is displayed on the display unit 206 (Step S11). In the example in FIG. 16, t can be considered that Projector 1 is selected as the input device and that requesting data (image data) being used (being projected) by Projector 1 as data for use in processing by an output device is selected.

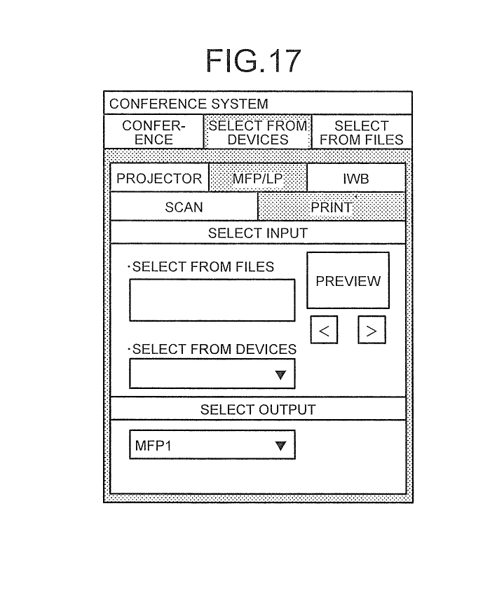

If the result at Step S10 is negative (No at Step S10), and if an operation to select the output device has been received (Yes at Step S12), the display controller 213 displays an output device selection screen as illustrated in FIG. 17 on the display unit 206 (Step S13). In the example in FIG. 17, it can be considered that MFP 1 is selected as the output device and that requesting print processing of the input file (the input file is in a state of being unselected in the example in FIG. 17) to MFP 1 is selected.

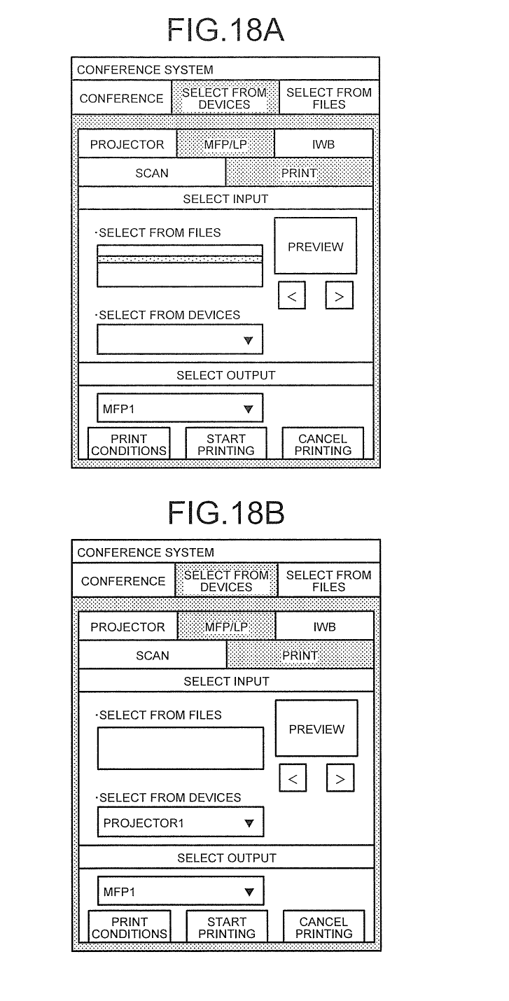

The pieces of processing at Step S8 and the subsequent steps are repeated until input/output settings are completed as described above, and if the input/output settings are completed (Yes at Step S14), the display controller 213 displays an instruction operating screen as illustrated in FIGS. 18A and 18B on the display unit 206 (Step S15). If an operation to instruct the execution of processing (an operation to press an icon of “start printing” in the example in FIGS. 18A and 18B) has been received via the instruction operating screen (Yes at Step S16), a command instruction is generated based on the set input/output, and the generated command instruction is transmitted to the information processing server 10 (Step S17).

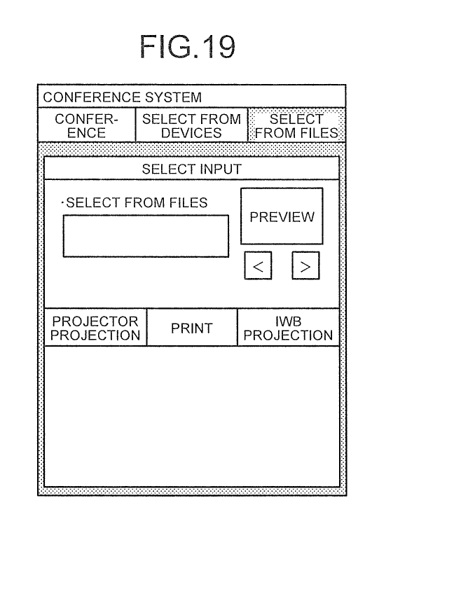

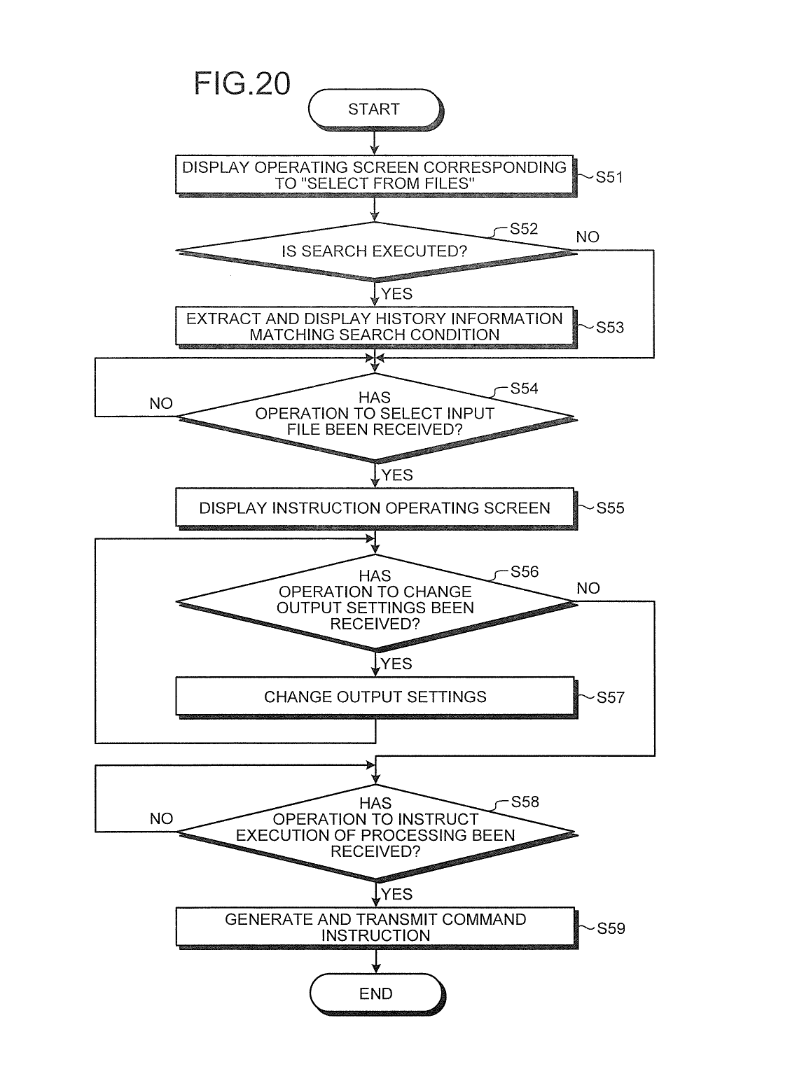

Next, if an operation to select an item of “select from files” (an operation to press an icon of “select from files”) has been received with the initial operating screen as illustrated in FIG. 8 displayed on the display unit 206, the display controller 213 displays the operating screen corresponding to “select from files” as illustrated in FIG. 19 on the display unit 206. The following describes an example of screen transition from the operating screen corresponding to “select from files” with reference to FIG. 20.

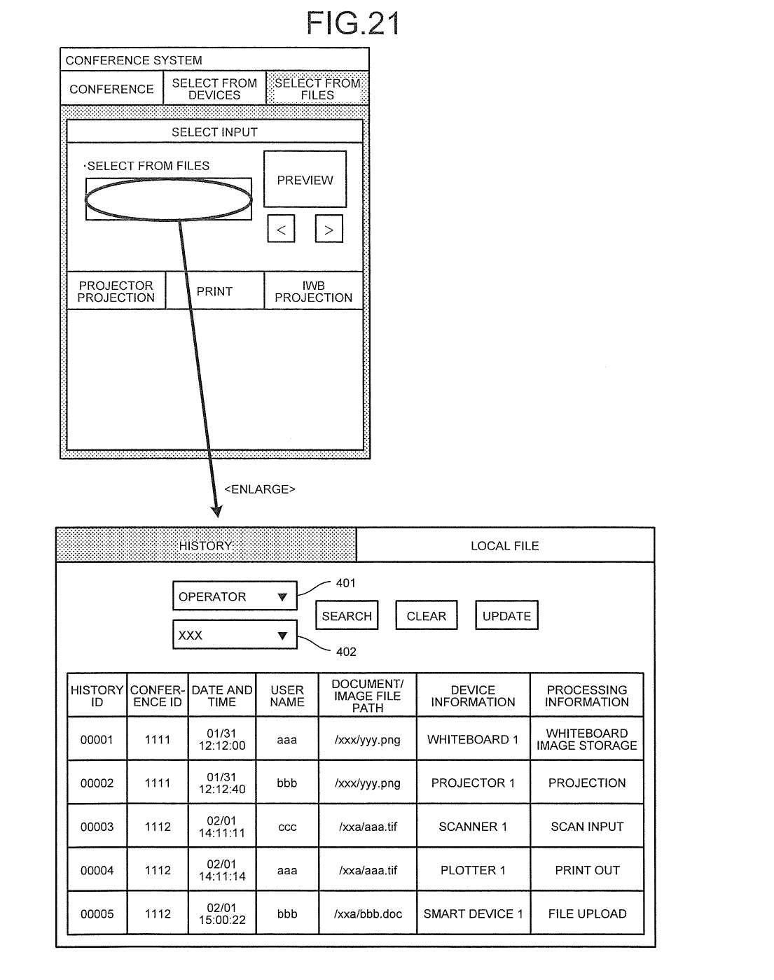

First, the display controller 213 displays the operating screen corresponding to “select from files” on the display unit 206 as illustrated in FIG. 20 (Step S51). In this situation, the information terminal 30 (the display controller 213, for example) acquires the history information (the history information with an amount that can be displayed by the information terminal 30) held in the history information database 117 from the information processing server 10 and displays the pieces of history information on the operating screen corresponding to “select from files” as illustrated in FIG. 21 If the above search processing is executed (Yes at Step S52), the display controller 213 performs control to display the history information matching the search condition among the pieces of history information displayed on the operating screen by default (Step S53), and the process advances to Step S54. If the search processing is not executed (No at Step S52), the process advances to Step S54 without being processed. Specific contents of the search processing are as described above.

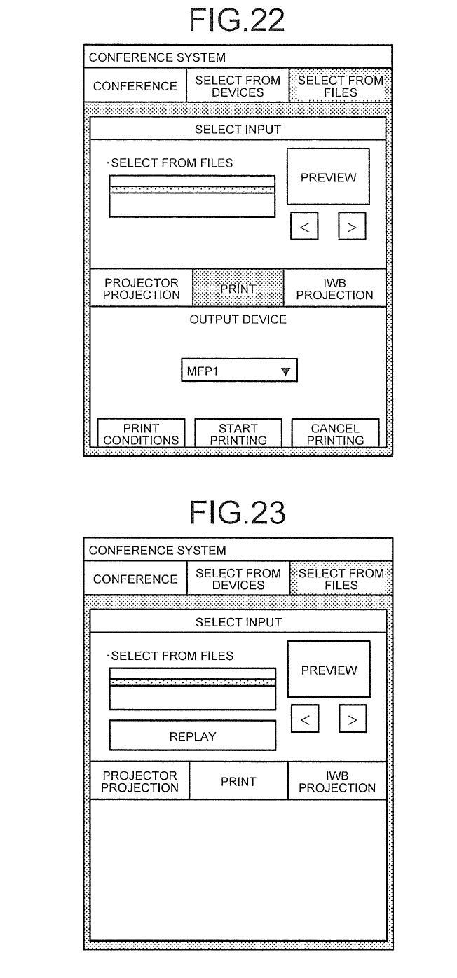

If an operation to select the input file has been received at Step S54 (Yes at Step S54), the process advances to Step S55. The following describes a case in which an operation to select any history information has been received as the input file as an example. In this case, so that a job corresponding to the selected history information will be reproduced, the display controller 213 automatically sets the device indicated by the device information contained in the history information and a function corresponding to the processing content indicated by the processing information contained in the history information as output settings and displays the instruction operating screen as illustrated in FIG. 22 on the display unit 206 (Step S55). The example in FIG. 22 assumes a case in which the device information contained in the selected history information indicates “MFP 1” and the processing information contained in the history information indicates “print.”

If an operation to change the output settings has been received (Yes at Step S56), the output settings are changed in accordance with the received operation (Step S57). If an operation to change the output settings is not received for a certain period (No at Step S56), and if an operation to instruct the execution of the processing (an operation to press an icon of “start printing” in the example in FIG. 22) has been received (Yes at Step S58), a command instruction is generated based on the set input/output, and the generated command instruction is transmitted to the information processing server 10 (Step S59).

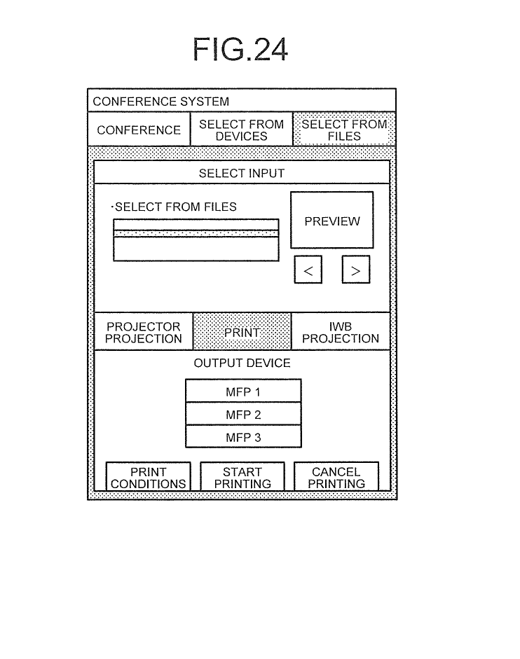

In this example, it can be considered that an operation to select any history information and to instruct the execution of the processing without changing the output settings corresponds to an operation to instruct the reproduction of the selected history information. Without limited to the above, a form is possible in which even when any history information is selected, the output settings are not automatically performed, and after any history information is selected, the output settings are performed in accordance with a user's operation, for example. In this form, when receiving an operation to select an output function type via the operating screen in which any history information has been selected as the input file as illustrated in FIG. 23, the display controller 213 can display devices that can provide the selected function (it is assumed that “print” has been selected in this example) as candidates of the output device as illustrated in FIG. 24 and set the output device in accordance with a selection operation by the user, for example. In this form, an icon of “replay” is displayed on the operating screen in a state before selecting the output function type (the operating screen illustrated in FIG. 23 in this example), and when the pressing of this icon has been received, the device indicated by the device information contained in the selected history information and the function corresponding to the processing content indicated by the processing information contained in the history information can automatically be set to display the instruction operating screen on the display unit 206. In this example, it can be considered that the operation to press the icon of “replay” corresponds to the operation to instruct the reproduction of the selected history information.

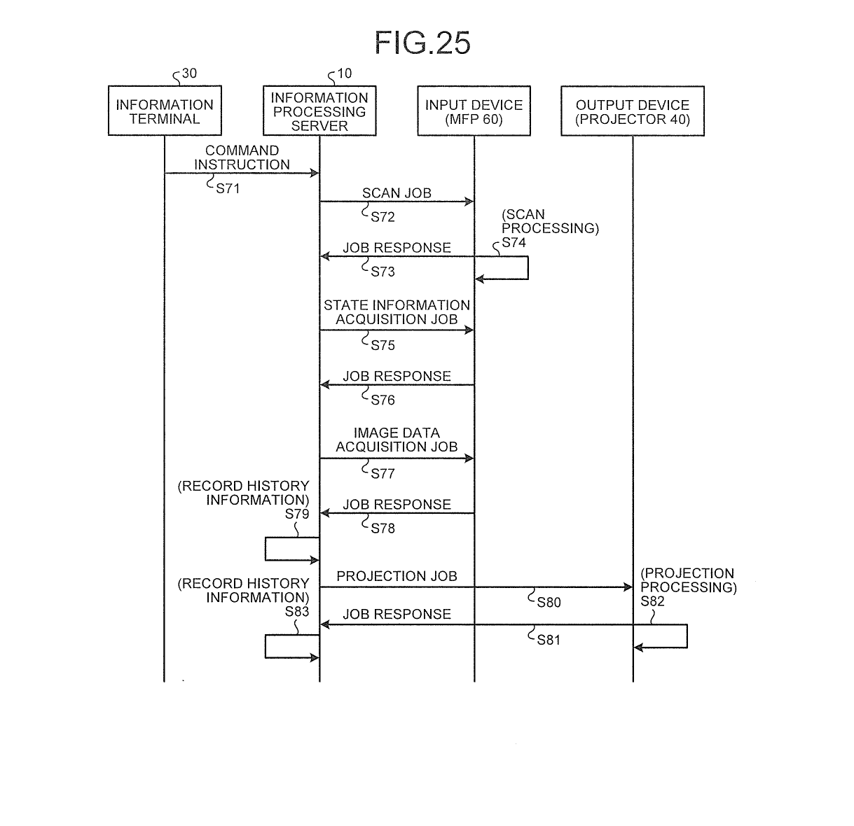

FIG. 25 is a sequence diagram of an example of a processing procedure of an inter-device cooperative operation (a procedure of cooperative processing). The following describes a case in which the information terminal 30 has generated a command instruction indicating that an image read by a scan function of the MFP 60 is projected by the projector 40 in the above procedure as an example. In this example, the input device is the MFP 60, whereas the output device is the projector 40.

First, as illustrated in FIG. 25, the information terminal 30 transmits the generated command instruction to the information processing server 10 (Step S71). The information processing server 10 that has received the command instruction analyzes the received command instruction and generates (constructs) a job required for the cooperative processing. In this example, the information processing server 10 first generates a scan job that instructs the MFP 60 to execute scan processing that reads an image from a document and transmits the generated scan job to the MFP 60 (Step S72). The MFP 60 that has received the scan job returns a job response to the information processing server 10 (Step S73) and executes the scan processing (Step S74). The information processing server 10 then periodically transmits a state information acquisition job that requests the acquisition of state information indicating the state of a device to the MFP 60 (Step S75). The MFP 60 that has received the state information acquisition job returns the state information indicating the current state of the MFP 60 to the information processing server 10 as a job response (Step S76). When acquiring the state information indicating that the scan processing is completed as the job response, the information processing server 10 transmits an image data acquisition job that requests the acquisition of image data obtained by the scan processing to the MFP 60 (Step S77). The MFP 60 that has received the image data acquisition job returns the image data obtained by the scan processing to the information processing server 10 as a job response (Step S78). The information processing server 10 records the image data acquired as the job response in the conference information database 119, generates the above history information, and records the history information in the history information database 117 (Step S79). The history information in this case contains the date and time when the image data obtained by the scan processing was acquired, the user name indicating the user of the information terminal 30 that issued the command instruction, information that can identify a stored position of the mage data (a file path, for example) in the conference information database 119, the device information indicating the MFP 60, and the processing information indicating the scan processing in addition to the history ID and the conference ID.

Next, the information processing server 10 generates a projection job that instructs the projector 40 to execute projection processing that projects the image data obtained by the scan processing and transmits the generated projection job to the projector 40 (Step S80). The projection job contains the image data obtained by the scan processing in addition to instruction information. The projector 40 that has received the projection job returns a job response to the information processing server 10 (Step S81) and executes the projection processing in accordance with the projection job (Step S82). The information processing server 10 that has received the job response generates the above history information and records the history information in the history information database 117 (Step S83). The history information in this case contains the date and time when the job response to the projection job was received, the user name indicating the user of the information terminal 30 that issued the command instruction, information that can identify a stored position of the image data (the image data obtained by the scan processing in this example) used in the projection processing in the conference information database 119, the device information indicating the projector 40, and the processing information indicating the projection processing in addition to the history ID and the conference ID.

As described above, the present embodiment displays the screen (the operating screen of the information terminal 30) in which one or more pieces of history information are displayed and that is used for performing the designation of the processing based on the history information selected from the displayed one or more pieces of history information and the designation of the device that is caused to execute the processing and generates the instruction information for instructing the designated device on the screen to execute the processing of the data corresponding to the history information selected from one or more pieces of history information on the displayed screen. The present embodiment can easily identify data that requires certain processing or reprocessing from the displayed history information and can thereby improve operability when an instruction about to which device the identified data is output is performed. The present embodiment can immediately instruct reprojection, redisplay, or the like from the history information to a request, in a conference, to see data projected or displayed during the conference again.

Although in the above embodiment, the information processing server 10 generates the job based on the command instruction received from the information terminal 30, this is not limiting, and a form is possible in which the information terminal 30 generates a job that instructs the execution of the processing using the data contained in the selected history information based on a user's operation received on the screen containing one or more pieces of history information, for example. In this form, it can also be considered that the information terminal 30 is an example of an “information terminal.” The system 100 of the present embodiment is only required to be a form having the functions of displaying the screen in which one or more pieces of history information are displayed and that is used for performing the designation of the processing based on the history information selected from the displayed one or more pieces of history information and the designation of the device that is caused to execute the processing and generating the instruction information for instructing the designated device on the screen to execute the processing of the data corresponding to the history information selected from one or more pieces of history information on the displayed screen.

### Second Embodiment

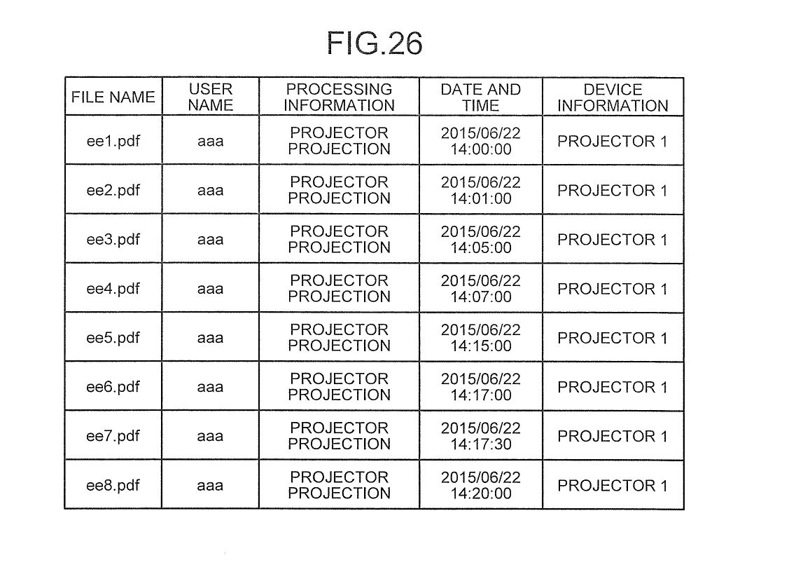

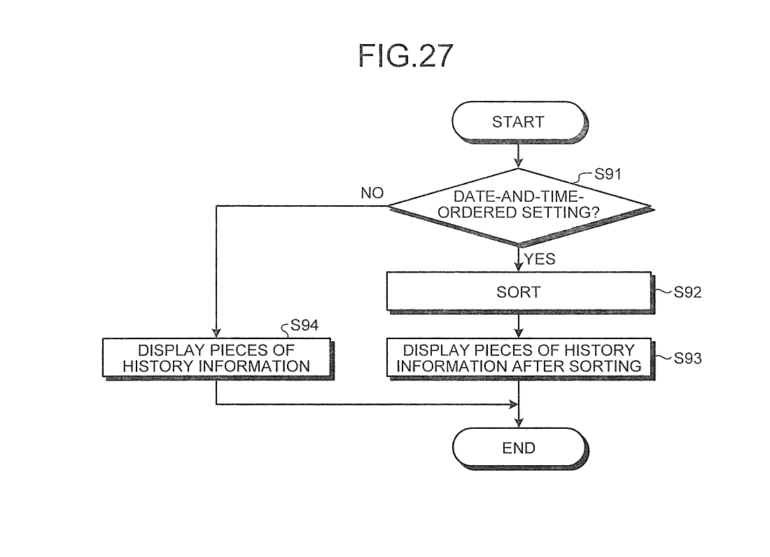

The following describes a second embodiment. For parts common to the first embodiment, descriptions thereof will appropriately be omitted. In the present embodiment, as illustrated in FIG. 26, the display controller 213 displays the pieces of history information obtained as the search result in ascending order of the date and time when the processing was performed. FIG. 27 is a flowchart of an example of processing after the pieces of history information have been obtained as a result of the search processing illustrated in FIG. 14. As illustrated in FIG. 27, the display controller 213 checks whether date-and-time-ordered setting that sets displaying a piece of history information having an earlier date and time when the processing was executed with priority is activated (Step S91). In this example, the information terminal 30 can switch between activation and deactivation of the date-and-time-ordered setting in accordance with a user's operation.

If the result at Step S91 is affirmative (Yes at Step S91), the pieces of history information obtained as the search result are sorted (Step S92). More specifically, the pieces of history information obtained as the search result are rearranged in ascending order of the date and time when the processing was executed. The pieces of history information after sorting are then displayed (Step S93). In contrast, if the result at Step S91 is negative (No at Step S91), the pieces of history information obtained as the search result are displayed as they are without being sorted (Step S94).

The present embodiment can preferentially display a piece of history information having an earlier date and time when the processing was executed.

### Third Embodiment

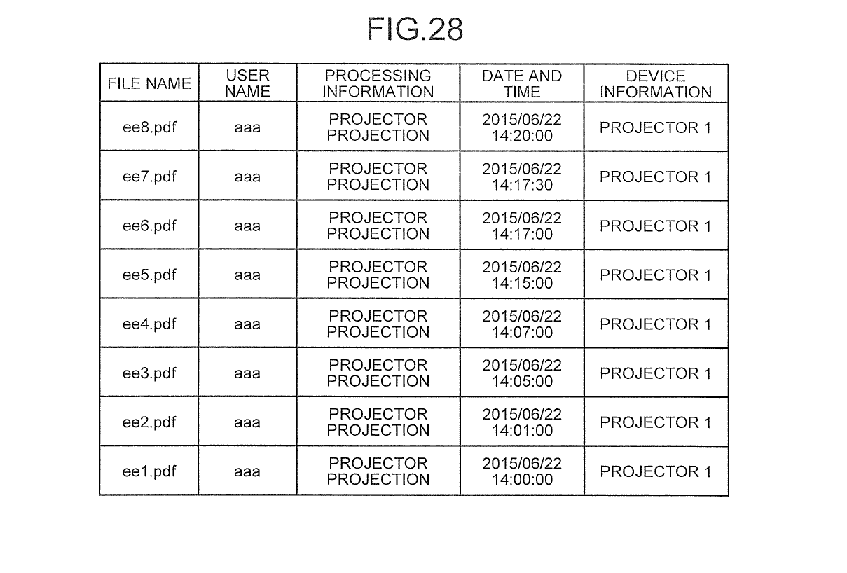

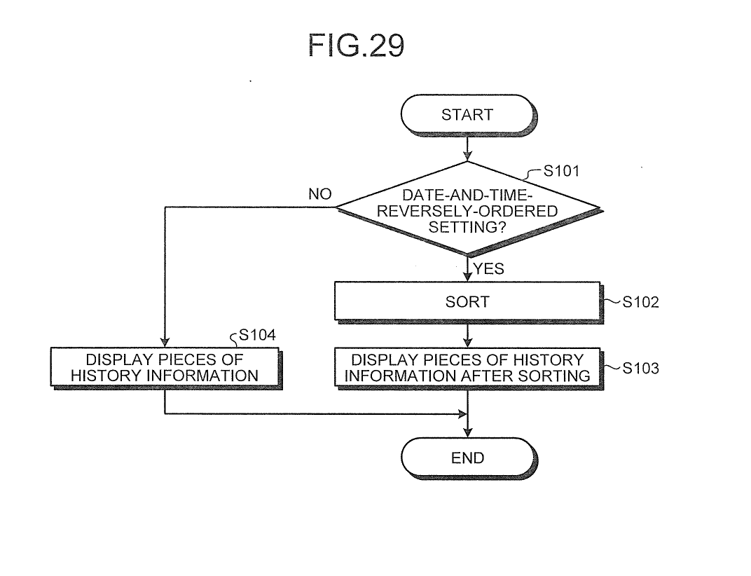

The following describes a third embodiment. For parts common to the above embodiments, descriptions thereof will appropriately be omitted. In the present embodiment, as illustrated in FIG. 28, the display controller 213 displays the pieces of history information obtained as the search result in descending order of the date and time when the processing was performed. FIG. 29 is a flowchart of an example of processing after the pieces of history information have been obtained as a result of the search processing illustrated in FIG. 14. As illustrated in FIG. 29, the display controller 213 checks whether date-and-time-reversely-ordered setting that sets displaying a piece of history information having a later date and time when the processing was executed with priority is activated (Step S101). In this example, the information terminal 30 can switch between activation and deactivation of the date-and-time-reversely-ordered setting in accordance with a user's operation.

If the result at Step S101 is affirmative (Yes at Step S101), the pieces of history information obtained as the search result are sorted (Step S102). More specifically, the pieces of history information obtained as the search result are rearranged in descending order of the date and time when the processing was executed. The pieces of history information after sorting are then displayed (Step S103). In contrast, if the result at Step S101 is negative (No at Step S101), the pieces of history information obtained as the search result are displayed as they are without being sorted (Step S104).

The present embodiment can display preferentially a piece of history information having a later date and time when the processing was executed.

### Fourth Embodiment

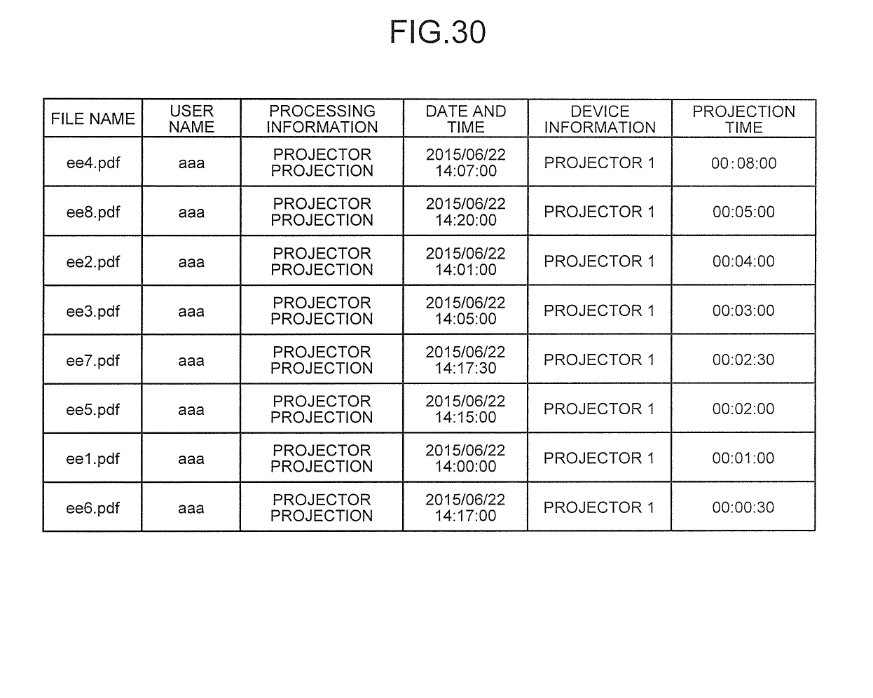

The following describes a fourth embodiment. For parts common to the above embodiments, descriptions thereof will appropriately be omitted. In the present embodiment, the history information further contains a processing time, and as illustrated in FIG. 30, the display controller 213 displays the pieces of history information obtained as the search result in descending order of the processing time (a projection time in the example in FIG. 30).

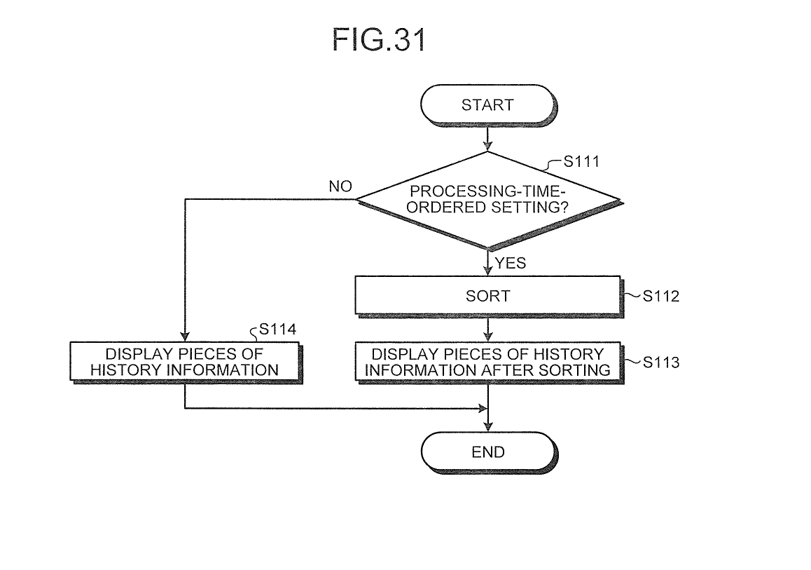

FIG. 31 is a flowchart of an example of processing after the pieces of history information have been obtained as a result of the search processing illustrated in FIG. 14. As illustrated in FIG. 31, the display controller 213 checks whether processing-time-ordered setting that sets displaying a piece of history information having a longer processing time with priority is activated (Step S111). In this example, the information terminal 30 can switch between activation and deactivation of the processing-time-ordered setting in accordance with a user's operation.

If the result at Step S111 is affirmative (Yes at Step S111), the pieces of history information obtained as the search result are sorted (Step S112). More specifically, the pieces of history information obtained as the search result are rearranged in descending order of the processing time. The pieces of history information after sorting are then displayed (Step S113). In contrast, if the result at Step S111 is negative (No at Step S111), the pieces of history information obtained as the search result are displayed as they are without being sorted (Step S114).

The present embodiment can display a piece of history information having a longer processing time with priority. It can be considered that a page projected for a longer time during a conference carries more important information, for example, and a piece of history information having a longer projection time is displayed with priority, whereby an important file can easily be found.

### Fifth Embodiment

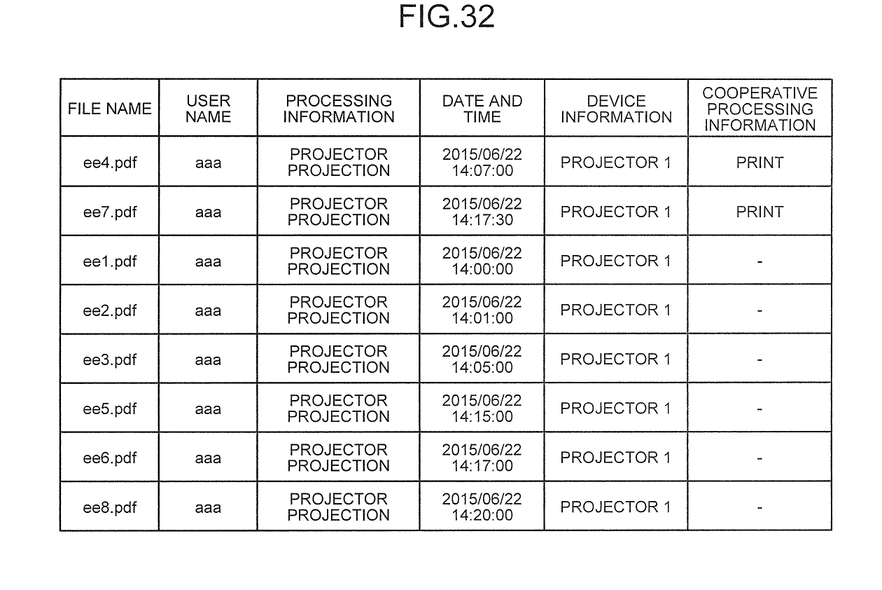

The following describes a fifth embodiment. For parts common to the above embodiments, descriptions thereof will appropriately be omitted. In the present embodiment, the history information is information that associates the processing, the device that has executed the processing, the processed data, and cooperative processing information indicating whether the processed data is an object of the cooperative processing that is executed in cooperation among two or more devices with each other, and as illustrated in FIG. 32, the display controller 213 displays pieces of history information containing the cooperative processing information indicating whether the processed data is an object of the cooperative processing among the pieces of history information obtained as the search result, arranged with priority. The cooperative processing in this example is assumed to be processing in which the projector and the MFP cooperate so as to perform print processing on the image data while being projected by the projector. In FIG. 32, the first and second pieces of history information from the top each indicate that it contains the cooperative processing information (the cooperative processing information indicating “print” in the example in FIG. 32) indicating whether the processed data is an object of the cooperative processing.

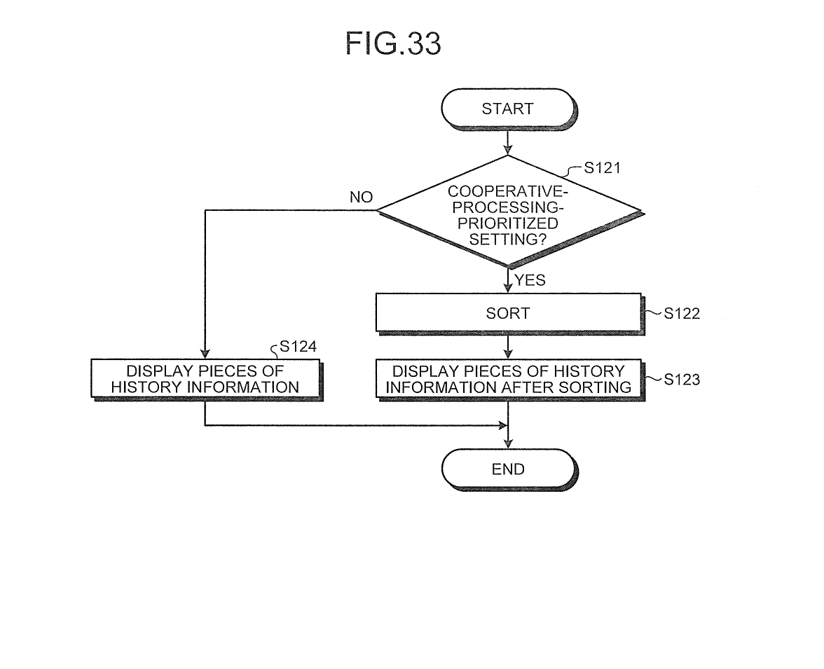

FIG. 33 is a flowchart of an example of processing after the pieces of history information have been obtained as a result of the search processing illustrated in FIG. 14. As illustrated in FIG. 33, the display controller 213 checks whether cooperative-processing-prioritized setting that sets displaying a piece of history information containing the cooperative processing information indicating whether the processed data is an object of the cooperative processing with priority is activated (Step S121). In this example, the information terminal 30 can switch between activation and deactivation of the cooperative-processing-prioritized setting in accordance with a user's operation.

If the result at Step S121 is affirmative (Yes at Step S121), the pieces of history information obtained as the search result are sorted (Step S122). More specifically, rearrangement is performed so that a piece of history information containing the cooperative processing information indicating whether the processed data is an object of the cooperative processing among the pieces of history information obtained as the search result will be displayed with priority. The pieces of history information after sorting are then displayed (Step S123). In contrast, if the result at Step S121 is negative (No at Step S121), the pieces of history information obtained as the search result are displayed as they are without being sorted (Step S124).

The data as the object of the cooperative processing often contains important information, and the history information containing the data is displayed with priority, whereby the user can easily find important data.

### Sixth Embodiment

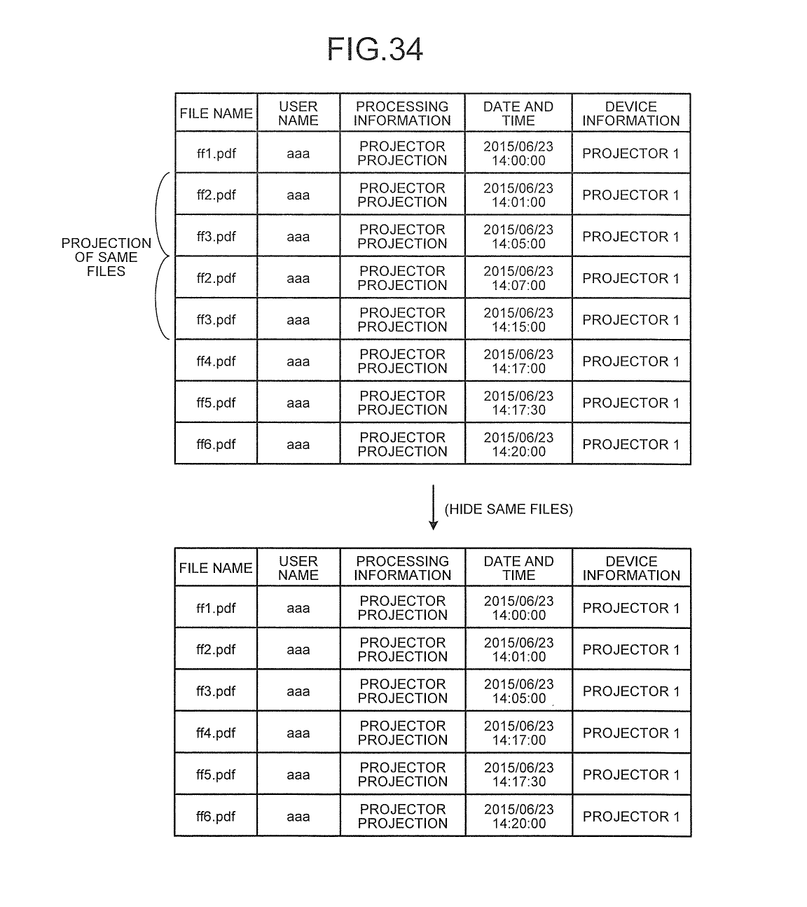

The following describes a sixth embodiment. For parts common to the above embodiments, descriptions thereof will appropriately be omitted. In the present embodiment, as illustrated in FIG. 34, the display controller 213 displays, for two or more pieces of history information that match in the processed data (the data handled in the processing), only any one piece of the history information among the pieces of history information obtained as the search result. With this operation, superfluous information can be hidden.

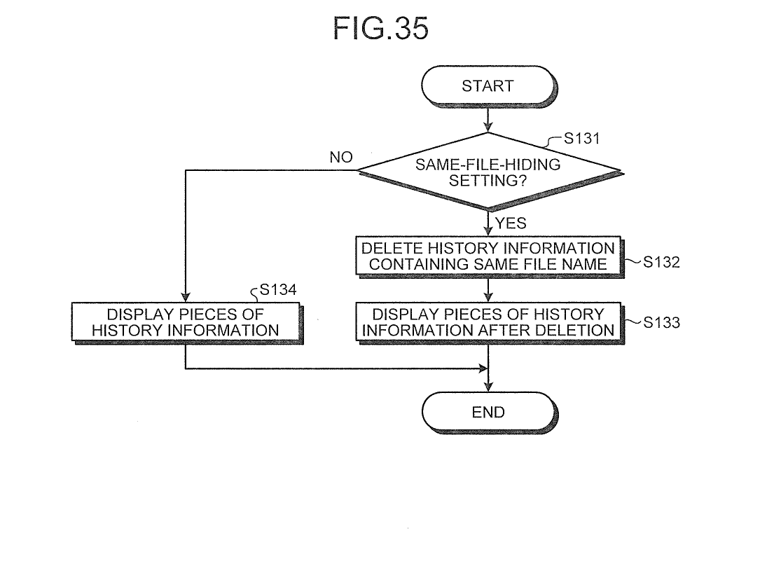

FIG. 35 is a flowchart of an example of processing after the pieces of history information have been obtained as a result of the search processing illustrated in FIG. 14. As illustrated in FIG. 35, the display controller 213 checks whether same-file-hiding setting that sets displaying, for two or more pieces of history information that match in the data handled in the processing, only any one piece of the history information is activated (Step S131). In this example, the information terminal 30 can switch between activation and deactivation of the same-file-hiding setting in accordance with a user's operation.

If the result at Step S131 is affirmative (Yes at Step S131), the pieces of history information containing the same file name among the pieces of history information obtained as the search result are deleted (Step S132). More specifically, for two or more pieces of history information containing the same file name among the pieces of history information obtained as the search result, any one piece of the history information is left, with the other piece of history information deleted. The pieces of history information after deletion (the left pieces of history information) are then displayed (Step S133). In contrast, if the result at Step S131 is negative (No at Step S131), the pieces of history information obtained as the search result are displayed as they are without being deleted (Step S134).

The information terminal 30 can also switch between activation and deactivation of at least one of the date-and-time-ordered setting, the date-and-time-reversely-ordered setting, the processing-time-ordered setting, and the cooperative-processing-prioritized setting described above in combination in accordance with a user's operation, for example. The display controller 213 may perform the above sorting (sorting of the pieces of history information obtained as the search result) in accordance with any activated setting.

The present embodiment displays, for two or more pieces of history information that match in the data handled in the processing, only any one piece of the history information and can thereby hide superfluous information.

Although the embodiments according to the present invention have been described, the present invention is not limited to the embodiments as they are and can be embodied with the components modified without departing from the essence thereof in an implementing stage. An appropriate combination of a plurality of components disclosed in the embodiments can form various kinds of inventions. Some components may be deleted from all the components disclosed in the embodiments, for example. Furthermore, components across different embodiments and modifications may appropriately be combined.

Computer programs executed by the system 100 of the embodiments may be recorded and provided in a computer-readable recording medium such as a compact disc read only memory (CD-ROM), a flexible disk (FD), a compact disc recordable (CD-R), a digital versatile disc (DVD), and universal serial bus (USB) as an installable or executable file or provided or distributed via a network such as the Internet. Various kinds of computer programs may be embedded in advance and provided in a ROM, for example.

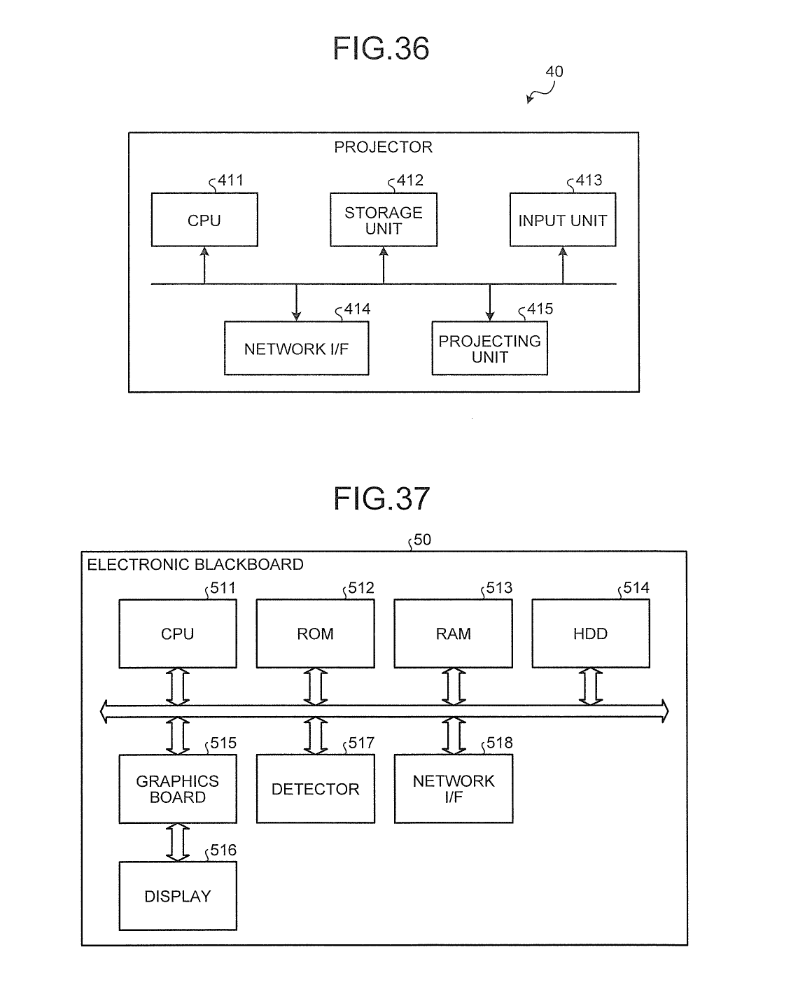

FIG. 36 is a schematic diagram of an example of a hardware configuration of the projector 40. As illustrated in FIG. 36, the projector 40 includes a CPU 411, a storage unit 412, an input unit 413, a network I/F 414, and a projecting unit 415, which are connected with each other via a bus.

The CPU 411 executes a computer program stored in the storage unit 412 and comprehensively controls the operation of the projector 40. The storage unit 412 includes a ROM and an HDD that store therein the computer program that the CPU 411 executes and data required for the execution of the computer program, and a RAM that functions as a work area of the CPU 411. The input unit 413 performs various kinds of input to the projector 40 and is a touch panel, a key switch, or the like. The network I/F 414 is an interface for connecting the projector 40 to the network. The projecting unit 415 projects image data as an object to be projected onto a projected object such as a screen. The projecting unit 415 includes an optical system for projection such as projection lenses, for example.

FIG. 37 is a schematic diagram of an example of a hardware configuration of the electronic blackboard 50. As illustrated in FIG. 37, the electronic blackboard 50 includes a CPU 511, a ROM 512, a RAM 513, a hard disk drive (HDD) 514, a graphics board 515, a display 516, a detector 517, and a network I/F 518, which are connected with each other via a bus.

The CPU 511 reads a computer program stored in the ROM 512, the HDD 514, or the like onto the RAM 513 to execute it and comprehensively controls the operation of the electronic blackboard 50. The graphics board 515 is an apparatus that processes drawing data to be drawn on the display 516 and includes a video RAM (VRAM) that holds images and connecting terminals of the display 516. The display 516 is a display apparatus that displays the drawing data generated by the graphics board 515.

The detector 517 is a detector that detects the fact that an object has been in contact therewith or close thereto. A touch panel including a capacitance sensor that detects capacitance that changes caused by contact with an object (a finger, an exclusive stylus pen, or the like) corresponds to the detector 517, for example. When contact position coordinates or close position coordinates are detected by the detector 517, the graphics board 515 draws a drawn image (a hand-drawn image) based on the detected contact position coordinates or close position coordinates and draws the drawn image on a background image in a superimposed manner. The network I/F 518 is an interface for connecting the electronic blackboard 50 to the network 70.

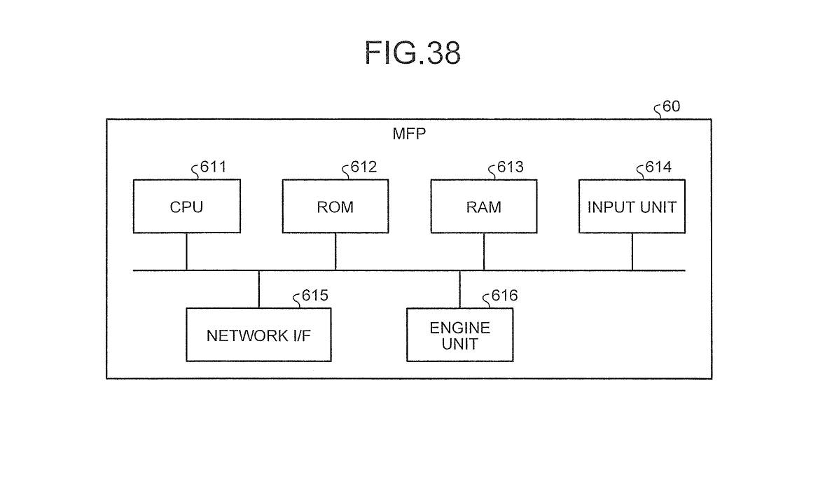

FIG. 38 is a schematic diagram of an example of the MFP 60. As illustrated in FIG. 38, the MFP 60 includes a CPU 611, a ROM 612, a RAM 613, an input unit 614, a network I/F 615, and an engine unit 616, which are connected with each other via a bus.

The CPU 611 reads a computer program stored in the ROM 612 or the like onto the RAM 613 to execute it and comprehensively controls the operation of the MFP 60. The input unit 614 performs various kinds of input to the MFP 60 and is a touch panel, a key switch, or the like. The network I/F 615 is an interface for connecting the MFP 60 to the network.

The engine unit 616 is hardware that performs versatile information processing and processing other than communication for implementing a copy function, a scanner function, a fax function, and a printer function. The engine unit 616 includes a scanner (an image reading unit) that scans and reads an image of a document, a plotter (an image forming unit) that performs printing on a sheet material such as paper, and a fax unit that performs fax communication, for example.

Exemplary embodiments of the present invention can improve operability when an instruction about to which device the previously handled data is output is performed.

The above-described embodiments are illustrative and do not limit the present invention. Thus, numerous additional modifications and variations are possible in light of the above teachings. For example, at least one element of different illustrative and exemplary embodiments herein may be combined with each other or substituted for each other within the scope of this disclosure and appended claims. Further, features of components of the embodiments, such as the number, the position, and the shape are not limited the embodiments and thus may be preferably set. It is therefore to be understood that within the scope of the appended claims, the disclosure of the present invention may be practiced otherwise than as specifically described herein.

The method steps, processes, or operations described herein are not to be construed as necessarily requiring their performance in the particular order discussed or illustrated, unless specifically identified as an order of performance or clearly identified through the context. It is also to be understood that additional or alternative steps may be employed.

Further, any of the above-described apparatus, devices or units can be implemented as a hardware apparatus, such as a special-purpose circuit or device, or as a hardware/software combination, such as a processor executing a software program.

Further, as described above, any one of the above-described and other methods of the present invention may be embodied in the form of a computer program stored in any kind of storage medium. Examples of storage mediums include, but are not limited to, flexible disk, hard disk, optical discs, magneto-optical discs, magnetic tapes, nonvolatile memory, semiconductor memory, read-only-memory (ROM), etc.

Alternatively, any one of the above-described and other methods of the present invention may be implemented by an application specific integrated circuit (ASIC), a digital signal processor (DSP) or a field programmable gate array (FPGA), prepared by interconnecting an appropriate network of conventional component circuits or by a combination thereof with one or more conventional general purpose microprocessors or signal processors programmed accordingly.

Each of the functions of the described embodiments may be implemented by one or more processing circuits or circuitry. Processing circuitry includes a programmed processor, as a processor includes circuitry. A processing circuit also includes devices such as an application specific integrated circuit (ASIC), digital signal processor (DSP), field programmable gate array (FPGA) and conventional circuit components arranged to perform the recited functions.

What is claimed is:

1. A system that comprises an information terminal, an information processing apparatus, and one or more devices that execute processing of data received from the information processing apparatus, the system comprising:
a storage unit configured to store therein history information associating a device that has executed the processing and the processed data with each other;
a display controller configured to display, on the information terminal, a screen in which one or more pieces of history information are displayed and that is used for performing designation of processing based on the history information selected from the displayed one or more pieces of history information and designation of a device to be caused to execute the processing;
a generating unit configured to generate instruction information for instructing the device designated on the screen to execute the processing of data corresponding to the history information selected from the one or more pieces of history information on the screen displayed by the display controller; and
a processing executing unit configured to execute the processing of the data based on the instruction information generated by the generating unit.

2. The system according to claim 1, wherein
the screen receives selection of any of one or more pieces of history information and receives designation of the processing using data contained in the selected history information and designation of a device to execute the designated processing using data contained in the selected history information.

3. The system according to claim 2, wherein
the generating unit generates the instruction information that instructs the designated device to execute the designated processing using data contained in the selected history information.

4. The system according to claim 1, wherein
the display controller performs control to search a plurality of pieces of history information for the history information that matches a search condition and to display the history information obtained as a search result on the screen.

5. The system according to claim 4, wherein
the history information is information associating a processing, a device that has executed the processing, and the processed data with each other, and
the search condition is set for searching for the history information containing the designated processing.

6. The system according to claim 4, wherein
the history information is information associating a processing, a device that has executed the processing, the processed data, and an operator who has instructed the execution of the processing with each other, and
the search condition is set for searching for the history information containing a designated operator.

7. The system according to claim 4, wherein
the history information further contains a date and time of the processing, and
the display controller displays the pieces of history information obtained as a search result in ascending order of the date and time of the processing.

8. The system according to claim 4, wherein
the history information further contains a date and time of the processing, and
the display controller displays the pieces of history information obtained as a search result in descending order of the date and time of the processing.

9. The system according to claim 4, wherein
the history information further contains a processing time, and
the display controller displays the pieces of history information obtained as a search result in descending order of the processing time.

10. The system according to claim 4, wherein
the history information is information associating a processing, a device that has executed the processing, the processed data, and cooperative processing information indicating whether the processed data is an object of cooperative processing that is executed in cooperation among two or more devices with each other, and
the display controller displays the history information containing the cooperative processing information indicating whether the processed data is an object of the cooperative processing among the pieces of history information obtained as a search result arranged with priority.

11. The system according to claim 4, wherein
the display controller displays, for two or more pieces of history information that match in the processed data, only any one piece of the history information among the pieces of history information obtained as a search result.

12. A method for processing information by a system that comprises an information terminal, an information processing apparatus, and one or more devices that execute processing of data received from the information processing apparatus, the method comprising:
displaying, on the information terminal, a screen in which one or more pieces of history information stored in a storage unit that stores therein history information associating a device that has executed the processing and the processed data with each other is displayed and that is used for performing designation of processing based on the history information selected from the displayed one or more pieces of history information and designation of a device to be caused to execute the processing;
generating instruction information for instructing the device designated on the screen to execute the processing of data corresponding to the history information selected from the one or more pieces of history information on the screen displayed at the displaying; and
executing the processing of the data based on the instruction information generated at the generating.

13. The method according to claim 12, wherein
the screen receives selection of any of one or more pieces of history information and receives designation of the processing using data contained in the selected history information and designation of a device to execute the designated processing using data contained in the selected history information.

14. The method according to claim 13, wherein
at the generating, generated is the instruction information that instructs the designated device to execute the designated processing using data contained in the selected history information.

15. The method according to claim 12, wherein
at the displaying, performed is control to search a plurality of pieces of history information for the history information that matches a search condition and to display the history information obtained as a search result on the screen.

16. The method according to claim 15, wherein
the history information is information associating a processing, a device that has executed the processing, and the processed data with each other, and
the search condition is set for searching for the history information containing the designated processing.

17. The method according to claim 15, wherein
the history information is information associating a processing, a device that has executed the processing, the processed data, and an operator who has instructed the execution of the processing with each other, and
the search condition is set for searching for the history information containing a designated operator.

18. The method according to claim 15, wherein
the history information further contains a date and time of the processing, and
at the displaying, displayed is the pieces of history information obtained as a search result in ascending order of the date and time of the processing.

19. The method according to claim 15, wherein
the history information further contains a date and time of the processing, and
at the displaying, displayed is the pieces of history information obtained as a search result in descending order of the date and time of the processing.

20. An information terminal connected to an information processing apparatus and one or more devices that execute processing of data received from the information processing apparatus via a network, the information terminal comprising:
a display controller configured to display a screen in which one or more pieces of history information stored in a storage unit that stores therein history information associating a device that has executed the processing and the processed data with each other is displayed and that is used for performing designation of processing based on the history information selected from the displayed one or more pieces of history information and designation of a device to be caused to execute the processing; and
a generating unit configured to generate instruction information for instructing the device designated on the screen to execute the processing of data corresponding to the history information selected from the one or more pieces of history information on the screen displayed by the display controller.
